(19) United States
(12) Patent Application Publication
(10) Pub. No.: US 2026/0247046 A1
(43) Pub. Date: Aug. 20, 2026

(54) LIGHT DETECTION DEVICE, FILM THICKNESS MEASUREMENT DEVICE, SEMICONDUCTOR PROCESS MONITORING DEVICE, AND NOISE DETECTION METHOD

(71) Applicant: HAMAMATSU PHOTONICS K.K., Hamamatsu-shi, Shizuoka (JP)

(72) Inventors: Kosuke FUJIMORI, Shizuoka (JP); Kenichi OHTSUKA, Shizuoka (JP); Kazuya IGUCHI, Shizuoka (JP)

(21) Appl. No.: 19/489,591

(22) PCT Filed: Mar. 14, 2024
(86) PCT No.: PCT/JP2024/010113

§ 371 Date: Dec. 3, 2025

(30) Foreign Application Priority Data
Jul. 31, 2023 (JP) 2023-124254

(51) Int. Cl. H04N 25/62; G01B 11/06; G01J 3/28; H04N 25/713; H04N 25/78

(52) U.S. Cl. CPC H04N 25/62; G01B 11/06; G01J 3/2803; H04N 25/713; H04N 25/78

(57) ABSTRACT

In a light detection device, a processing unit sets a threshold for each of a plurality of channels, and identifies a channel in which noise is included in a first signal or a second signal based on the threshold and a difference between the first signal and the second signal in each of the plurality of channels. The threshold is set for each of the plurality of channels based on the first signal and the second signal.

### TECHNICAL FIELD

One aspect of the present disclosure relates to a light detection device, a film thickness measurement device, a semiconductor process monitoring device, and a noise detection method.

### BACKGROUND ART

Patent Literature 1 describes an image sensor that continuously performs observation by two lines (first and second lines) including a plurality of photosensitive pixels, and an image capture method using the image sensor. In the method described in Patent Literature 1, a difference between digital values from pixels of first and second lines is calculated in order to detect a pixel broken by a collision of a space particle, a result of the subtraction is compared with a threshold, and when the result is less than the threshold, the digital values are considered to be acceptable, while when the result is more than the threshold, the digital values are considered to be unacceptable. The threshold is set to a constant value larger than readout noise of the sensor.

### CITATION LIST

### Patent Literature

Patent Literature 1: Japanese Unexamined Patent Publication No. 2017-522823

### SUMMARY OF INVENTION

### Technical Problem

The present inventors have found that, for example, when the method described in Patent Literature 1 is applied to detection of sudden noise caused by a cosmic ray, erroneous detection may occur, and there is a possibility that noise cannot be detected accurately.

An object of one aspect of the present disclosure is to provide a light detection device, a film thickness measurement device, a semiconductor process monitoring device, and a noise detection method, capable of detecting noise accurately.

### Solution to Problem

A light detection device according to one aspect of the present disclosure is [1] “a light detection device including: a light detector that detects measurement light; and a processing unit that processes data output from the light detector, in which the light detector includes: a first detection unit including a plurality of first pixel columns arranged along a first direction, each of the plurality of first pixel columns including at least one pixel arranged along a second direction perpendicular to the first direction; and a second detection unit including a plurality of second pixel columns arranged along the first direction, each of the plurality of second pixel columns including at least one pixel arranged along the second direction, the first detection unit and the second detection unit are arranged so as to be adjacent to each other in the second direction, the light detector outputs a first signal and a second signal to the processing unit, in which the first signal is one-dimensional data in the first direction of the measurement light detected by the first detection unit, in which the second signal is one-dimensional data in the first direction of the measurement light detected by the second detection unit, the light detector has a plurality of channels arranged along the first direction assuming that one channel is formed by the first pixel column and the second pixel column arranged in the second direction, the processing unit sets a threshold for each of the plurality of channels, and identifies the channel in which noise is included in the first signal or the second signal based on the threshold and a difference between the first signal and the second signal in each of the plurality of channels, and the threshold is set for each of the plurality of channels based on the first signal and the second signal”.

In this light detection device, the processing unit sets a threshold for each of a plurality of channels, and identifies a channel in which noise is included in a first signal or a second signal based on the threshold and a difference between the first signal and the second signal in each channel. The threshold is set for each channel based on the first signal and the second signal. In this manner, by setting the threshold for each channel based on the first signal and the second signal, noise can be detected accurately as compared with, for example, a case where the threshold is set to a constant value regardless of a channel.

A light detection device according to one aspect of the present disclosure may be [2] “the light detection device according to [1], in which the threshold is set for each of the plurality of channels based on the magnitude of the first signal and the magnitude of the second signal in the channel”. In this case, the threshold can be suitably set, and noise can be detected more accurately.

A light detection device according to one aspect of the present disclosure may be [3] “the light detection device according to [1] or [2], in which the threshold is set based on a difference between a value of the first signal in the channel and a value of the first signal in a first proximity channel proximate to the channel, and a difference between a value of the second signal in the channel and a value of the second signal in a second proximity channel proximate to the channel”. In this case, the threshold can be suitably set, and noise can be detected more accurately.

A light detection device according to one aspect of the present disclosure may be [4] “the light detection device according to any one of [1] to [3], in which the processing unit creates threshold addition data obtained by adding the threshold to whichever of the first signal and the second signal is smaller for each of the plurality of channels, and compares the first signal and the second signal with the threshold addition data to identify the channel in which noise is included in the first signal or the second signal”. In this case, noise detection can be suitably performed.

A light detection device according to one aspect of the present disclosure may be [5] “the light detection device according to any one of [1] to [4], in which the first signal is the one-dimensional data of the measurement light detected in a first exposure time by the first detection unit, the second signal is the one-dimensional data of the measurement light detected in a second exposure time by the second detection unit, and the second exposure time is longer than the first exposure time”. In this case, a dynamic range can be increased by combining pieces of data having different exposure times.

A light detection device according to one aspect of the present disclosure may be [6] “the light detection device according to any one of [1] to [5], in which the processing unit interpolates a value of the channel identified as including the noise in the first signal or the second signal based on values of the channels on both sides of the channel”. In this case, an influence of noise on light detection can be reduced.

A light detection device according to one aspect of the present disclosure may be [7] “the light detection device according to any one of [1] to [6], in which the light detector is a CCD light detector including: a first horizontal shift register to which charges generated in the plurality of first pixel columns of the first detection unit are transferred; and a second horizontal shift register to which charges generated in the plurality of second pixel columns of the second detection unit are transferred”. In this case, it is possible to avoid an increase in readout noise when charges generated in each pixel are read out.

A light detection device according to one aspect of the present disclosure may be [8] “the light detection device according to any one of [1] to [6], in which the light detector is a CCD light detector including: a plurality of first accumulation units in which charges generated in the plurality of first pixel columns of the first detection unit are accumulated respectively; a plurality of second accumulation units in which charges generated in the plurality of second pixel columns of the second detection unit are accumulated respectively; a plurality of first readout units that are electrically connected to the plurality of first accumulation units, respectively, and output electric signals corresponding to the magnitude of charges accumulated in the plurality of first accumulation units; and a plurality of second readout units that are electrically connected to the plurality of second accumulation units, respectively, and output electric signals corresponding to the magnitude of charges accumulated in the plurality of second accumulation units”. Also in this case, it is possible to avoid an increase in readout noise when charges generated in each pixel are read out.

A light detection device according to one aspect of the present disclosure may be [9] “the light detection device according to any one of [1] to [6], in which the light detector is a CMOS light detector including: a first readout unit that outputs an electric signal corresponding to the magnitude of charges accumulated in each of the pixels of the first detection unit; and a second readout unit that outputs an electric signal corresponding to the magnitude of charges accumulated in each of the pixels of the second detection unit”. In this case, for example, power consumption can be reduced as compared with a CCD light detector that reads out charges for each column.

A spectrometer according to one aspect of the present disclosure is [10] “a spectrometer including: a spectroscopic unit that spectrally disperses the measurement light and forms an image over the first detection unit and the second detection unit; and the light detection device according to any one of [1] to [9], which detects the measurement light spectrally dispersed by the spectroscopic unit in the first detection unit and the second detection unit”. According to this spectrometer, noise can be detected accurately for the reasons described above.

A film thickness measurement device according to one aspect of the present disclosure is “a film thickness measurement device including: the spectrometer according to [10]; and a light source unit that generates light to be irradiated to an object, in which the processing unit measures a film thickness of the object based on data from which the noise has been removed”. According to this film thickness measurement device, a film thickness can be measured accurately based on data from which accurately detected noise has been removed for the reasons described above.

A film thickness measurement device according to one aspect of the present disclosure is “a film thickness measurement device including: the spectrometer according to [10]; and a light source unit that generates light to be irradiated to an object, in which the processing unit measures a film thickness of the object based on data from which the noise has been removed”. According to this film thickness measurement device, a film thickness can be measured accurately based on data from which accurately detected noise has been removed for the reasons described above.

A noise detection method according to one aspect of the present disclosure is [13] “a noise detection method using a light detector including: a first detection unit including a plurality of first pixel columns arranged along a first direction, each of the plurality of first pixel columns including at least one pixel arranged along a second direction perpendicular to the first direction; and a second detection unit including a plurality of second pixel columns arranged along the first direction, each of the plurality of second pixel columns including at least one pixel arranged along the second direction, the first detection unit and the second detection unit being arranged so as to be adjacent to each other in the second direction, in which the light detector includes a plurality of channels arranged along the first direction assuming that one channel is formed by the first pixel column and the second pixel column arranged in the second direction, the method including: a step of outputting a first signal that is one-dimensional data in the first direction of the measurement light detected by the first detection unit and a second signal that is one-dimensional data in the first direction of the measurement light detected by the second detection unit; a step of setting a threshold for each of the plurality of channels; and a step of identifying the channel in which noise is included in the first signal and the second signal based on the threshold and a difference between the first signal and the second signal in each of the plurality of channels, in which in the step of setting the threshold, the threshold is set for each of the plurality of channels based on the first signal and the second signal”. According to this noise detection method, noise can be detected accurately for the reasons described above.

### Advantageous Effects of Invention

According to one aspect of the present disclosure, it is possible to provide a light detection device, a film thickness measurement device, a semiconductor process monitoring device, and a noise detection method, capable of detecting noise accurately.

### BRIEF DESCRIPTION OF DRAWINGS

FIG. 1 is a diagram illustrating a configuration of a spectrometer according to an embodiment.

FIG. 2 is a diagram illustrating a configuration of a light detector.

FIG. 3 is a diagram illustrating a detection unit of the light detector.

FIG. 4(a) is a graph illustrating an example of a first signal, and FIG. 4(b) is a graph illustrating an example of a second signal.

FIG. 5 is a graph for explaining a method for detecting noise based on a difference between the first signal and the second signal.

FIG. 6 is a graph illustrating an example of a case where a threshold is set to a constant value.

FIG. 7 is a graph illustrating an example of a case where a threshold is set by a first method.

FIG. 8 is a graph illustrating another example of the case where the threshold is set by the first method.

FIG. 9 is a graph illustrating examples of the first signal and the second signal.

FIG. 10 is a diagram for explaining optical distortion occurring in the first signal and the second signal.

FIGS. 11(a) and 11(b) are diagrams for explaining the magnitude of optical distortion.

FIGS. 12(a) and 12(b) are diagrams for explaining discretization of a signal.

FIGS. 13(a) and 13(b) are diagrams for explaining a second method.

FIGS. 14(a) and 14(b) are diagrams for explaining the second method.

FIGS. 15(a) and 15(b) are diagrams for explaining the second method.

FIGS. 16(a) and 16(b) are diagrams for explaining a first example of the second method.

FIGS. 17(a) and 17(b) are diagrams for explaining a second example of the second method.

FIGS. 18(a) and 18(b) are diagrams for explaining a third example of the second method.

FIGS. 19(a) and 19(b) are diagrams for explaining a fourth example of the second method.

FIGS. 20(a) and 20(b) are diagrams for explaining a comparative example.

FIG. 21 is a graph illustrating an example of a case where the first method and the second method are combined.

FIGS. 22(a) and 22(b) are diagrams for explaining threshold addition data.

FIGS. 23(a) and 23(b) are graphs illustrating examples of an application result of the second method.

FIGS. 24(a) and 24(b) are graphs illustrating another example of the application result of the second method.

FIGS. 25(a), 25(b), and 25(c) are tables for explaining actual measurement results.

FIG. 26 is a diagram illustrating a first modification of the light detector.

FIG. 27 is a diagram illustrating the first modification of the light detector.

FIG. 28 is a diagram illustrating a second modification of the light detector.

FIG. 29 is a diagram illustrating an example of a film thickness measurement device.

### DESCRIPTION OF EMBODIMENTS

Hereinafter, an embodiment of the present disclosure will be described in detail with reference to the drawings. The following description will use the same reference signs for the same or equivalent elements, and repeated descriptions will be omitted.

### [Spectrometer]

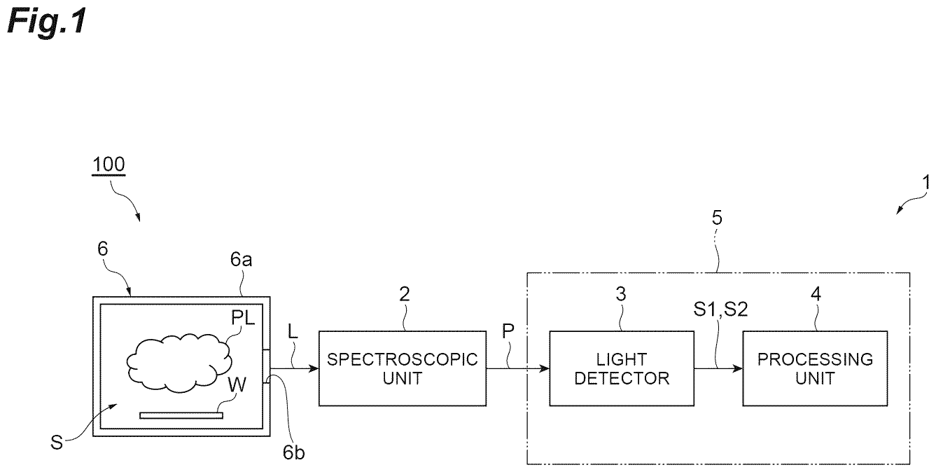

As illustrated in FIG. 1, a spectrometer 1 includes a spectroscopic unit 2, a light detector 3, and a processing unit 4. The spectrometer 1 spectrally disperses measurement light L coming from an object S by the spectroscopic unit 2 and detects the spectrally dispersed measurement light L by the light detector 3 to acquire spectrum data of the measurement light L.

In the example of FIG. 1, the spectrometer 1 constitutes a semiconductor process monitoring device 100. The semiconductor process monitoring device 100 includes the spectrometer 1 and a semiconductor process device 6 that processes a semiconductor device in a predetermined process. In this case, the object S is a semiconductor substrate (semiconductor wafer) (semiconductor device) processed in a semiconductor process, a gas used in the semiconductor process, plasma generated in the semiconductor process, or the like. The semiconductor process device 6 is, for example, a dry etching device used in a dry etching process or a film forming device used in a film forming process. The spectrometer 1 acquires spectrum data of the measurement light L coming from the object S in the semiconductor process device 6. FIG. 1 illustrates a case where the semiconductor process device 6 is a dry etching device, and a semiconductor substrate W is disposed in a chamber 6a. At the time of etching, an etching gas is introduced into the chamber 6a to generate plasma PL, and the semiconductor substrate W is etched by the plasma PL. The measurement light L from the dry etching device is incident on the spectroscopic unit 2, for example, via a window 6b formed in the chamber 6a. The measurement light L includes light caused by an etching gas and light caused by a material of the semiconductor substrate W. In this case, the processing unit 4 of the spectrometer 1 monitors an abnormality of the semiconductor process based on a detection result of the measurement light L. In particular, in the semiconductor process monitoring device 100, the processing unit 4 identifies a channel including noise by a noise detection method described later, removes the noise, and monitors an abnormality of the semiconductor process based on data from which the noise has been removed.

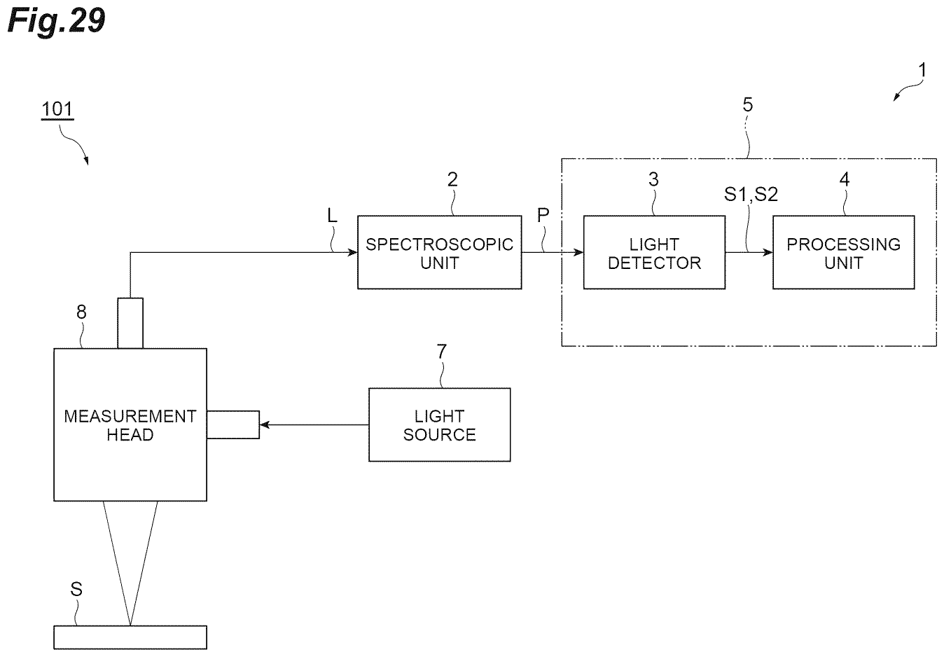

Alternatively, as illustrated in FIG. 29, the spectrometer 1 may constitute a film thickness measurement device 101. The film thickness measurement device 101 includes the spectrometer 1, a light source unit 7 that generates light to be irradiated to the object S, and a measurement head 8 that irradiates the object S with light. In this case, the object S is an optical film, a display panel, a semiconductor substrate (semiconductor wafer) (semiconductor device), or the like. The light source unit 7 is, for example, a white light source. The measurement head 8 includes, for example, a half mirror and a condensing lens. Light from the light source unit 7 is irradiated to the object S via the measurement head 8. Light reflected by or transmitted through the object S is input to the spectrometer 1 as the measurement light L via the measurement head 8. The film thickness measurement device 101 measures, for example, the film thickness of an optical film as the object S, the thickness of a thin film formed on a display panel, or the thickness of a thin film formed on a semiconductor wafer. In this case, the processing unit 4 of the spectrometer 1 measures the film thickness of the object S based on a detection result of the measurement light L. In particular, in the semiconductor process monitoring device 100, the processing unit 4 identifies a channel including noise by a noise detection method described later, removes the noise, and measures the film thickness of the object S based on data from which the noise has been removed. Alternatively, the object S may be a light emission quantum yield measurement object disposed in an integrating sphere. In this case, the measurement light L includes excitation light for exciting a measurement object and light (for example, fluorescence) generated in the measurement object.

The spectroscopic unit 2 spectrally disperses the measurement light L coming from the object S, and forms a spectral image on a detection region of the light detector 3. The spectroscopic unit 2 includes a spectroscopic element such as a grating or a prism, and divides the measurement light L into wavelength components. As the spectroscopic unit 2, a spectrometer having favorable image formation properties can be used. The spectroscopic element constituting the spectroscopic unit 2 may be, for example, a Czerny-Turner-type spectroscopic element, a Dyson-type spectroscopic element, or an Offner-type spectroscopic element, capable of astigmatism correction.

The light detector 3 detects the measurement light L spectrally dispersed by the spectroscopic unit 2. Details of the light detector 3 will be described later. The processing unit 4 processes data output from the light detector 3. The processing unit 4 is constituted by, for example, a computer including a processor such as a CPU and a storage medium such as a RAM or a ROM. The processing unit 4 may be constituted by a smart device such as a smartphone or a tablet terminal integrally including a display unit and an input unit, or may be constituted by a microcomputer or a field-programmable gate array (FPGA). The light detector 3 and the processing unit 4 can be regarded as constituting a light detection device 5 that detects the measurement light L spectrally dispersed by the spectroscopic unit 2.

### [Light Detector]

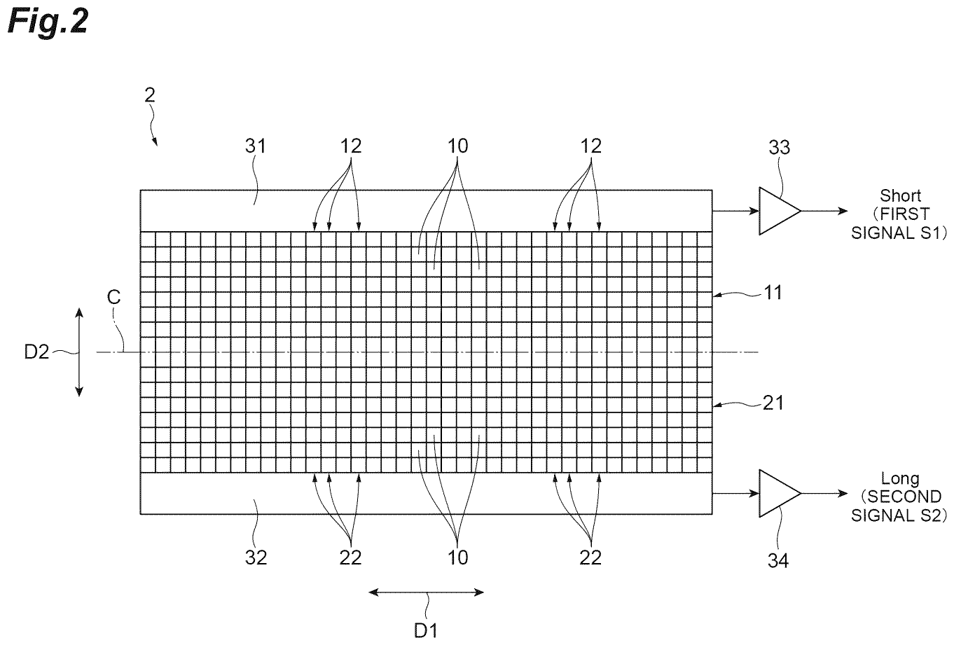

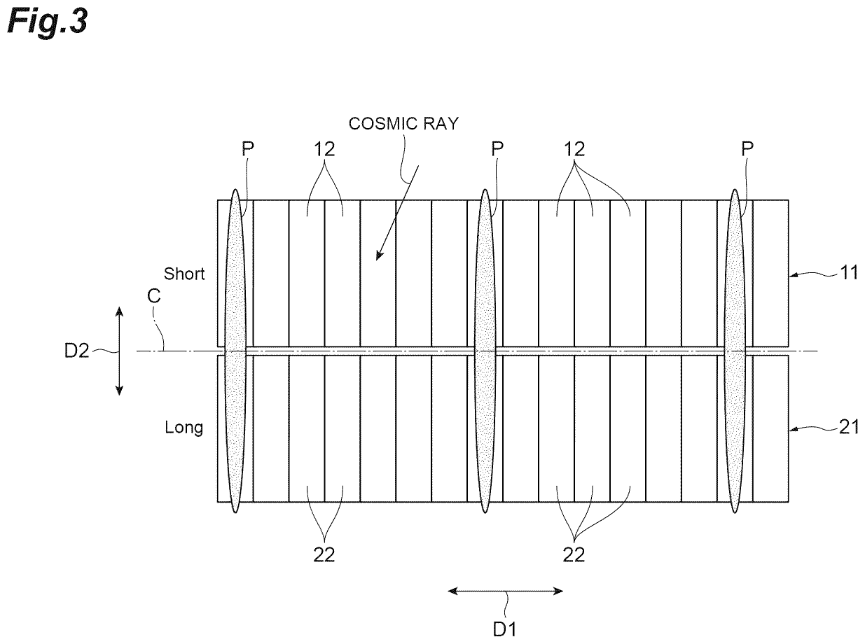

Details of the light detector 3 will be described with reference to FIGS. 2 and 3. As illustrated in FIGS. 2 and 3, the light detector 3 includes a first detection unit 11 and a second detection unit 21. The first detection unit 11 includes a plurality of first pixel columns 12 arranged in a first direction D1 (row direction). Each first pixel column 12 includes a plurality of pixels 10 arranged in a second direction D2 (column direction) perpendicular to the first direction D1. The second detection unit 21 includes a plurality of second pixel columns 22 arranged in the first direction D1. Each second pixel column 22 includes a plurality of pixels 10 arranged in the second direction D2. The second detection unit 21 is disposed adjacent to (facing) the first detection unit 11 in the second direction D2.

From a different point of view, in the light detector 3, the plurality of pixels 10 are arranged in the first direction D1 (row direction) and the second direction D2 (column direction), and the light detector 3 includes the first detection unit 11 and the second detection unit 21 which are two detection units divided in the second direction D2. In this example, the number of pixels in the first direction D1 is larger than the number of pixels in the second direction D2, and a detection region constituted by the first detection unit 11 and the second detection unit 21 has a rectangular shape having long sides parallel to the first direction D1. In both the first direction D1 and the second direction D2, the number of the pixels 10 arranged in the first detection unit 11 is equal to the number of the pixels 10 arranged in the second detection unit 21. That is, the first detection unit 11 and the second detection unit 21 are symmetric with respect to a center line C that passes through a center in the second direction D2 and is parallel to the first direction D1. Note that the first detection unit 11 and the second detection unit 21 may be constituted by different (separated from each other) light detection elements, or may be constituted by a common (one) light detection element.

Each second pixel column 22 is arranged so as to be aligned with the corresponding first pixel column 12 in the second direction D2 (that is, so as to be located on a straight line parallel to the second direction D2 together with the corresponding first pixel column 12). Therefore, the plurality of first pixel columns 12 and the plurality of second pixel columns 22 have pixel columns corresponding to each other, and the corresponding first pixel column 12 and second pixel column 22 are referred to as one channel. That is, in the light detector 3, it can also be said that a plurality of channels each extending in the second direction D2 are arranged in the first direction D1. Hereinafter, description will be given on the assumption that one channel is constituted by the first pixel column 12 and the second pixel column 22 arranged in the second direction D2. In this case, the light detector 3 includes a plurality of channels arranged in the first direction D1.

A spectral image P formed by the spectroscopic unit 2 is incident on a detection region (the first detection unit 11 and the second detection unit 21) of the light detector 3 (FIG. 3). In the example of FIGS. 2 and 3, the first direction D1 is along a wavelength-dispersing direction by the spectroscopic unit 2, and the second direction D2 is along a charge transfer direction in which charges generated in the pixel 10 are transferred. The spectral image P is incident on the detection region of the light detector 3 so as to extend over the first detection unit 11 and the second detection unit 21. In other words, the spectroscopic unit 2 is disposed such that the spectral image P is formed (imaged) over the first detection unit 11 and the second detection unit 21. Each pixel 10 receives the spectral image P that has been subjected to wavelength decomposition, and generates and accumulates charges according to the intensity of light. FIG. 3 illustrates three spectral images P having different wavelengths. The three spectral images P are formed in a state of being separated from each other in the first direction D1. As described above, incidence channels vary depending on the wavelength. That is, the spectral images P of the measurement light L incident on the channels have different wavelengths. Each spectral image P has, for example, a slit shape (vertically long shape) and extends in the second direction D2. A correspondence relationship between the channel and the wavelength in the first detection unit 11 is the same as that in the second detection unit 21.

A first exposure time of each pixel 10 in the first detection unit 11 and a second exposure time of each pixel 10 in the second detection unit 21 can be set independently of each other. In the present embodiment, the second exposure time is set to be longer than the first exposure time.

The light detector 3 outputs a first signal S1 that is one-dimensional data in the first direction D1 of the measurement light L detected in the first exposure time by the first detection unit 11, and a second signal S2 that is one-dimensional data in the first direction D1 of the measurement light detected in the second exposure time by the second detection unit 21 to the processing unit 4. Hereinafter, this output operation will be described. Note that since the first exposure time is shorter than the second exposure time in the present embodiment as described above, the first signal S1 is described as “Short” and the second signal S2 is described as “Long” in FIG. 2. In FIG. 3, “Short” is described on a first detection unit 11 side, and “Long” is described on a second detection unit 21 side.

In the example of FIG. 2, the light detector 3 is a charge coupled device (CCD) light detector including a first horizontal shift register 31 and a second horizontal shift register 32. The first horizontal shift register 31 and the second horizontal shift register 32 are signal processing units that process signals generated by the first detection unit 11 and the second detection unit 21.

In the first detection unit 11, charges generated and accumulated in each pixel 10 are transferred to the first horizontal shift register 31 in the second direction D2, and charges of the pixels 10 in each first pixel column 12 are summed forsummed for each column in the first horizontal shift register 31 (hereinafter, this operation is referred to as “vertical transfer”). That is, in the light detector 3, signals of the plurality of pixels 10 included in the first pixel column 12 are added (subjected to analog binning) to be an output signal from the first pixel column 12. Therefore, the plurality of pixels 10 included in one first pixel column 12 (channel) can be regarded as constituting one pixel.

Subsequently, the charges summed forsummed for each column in the first horizontal shift register 31 are sequentially read from the first horizontal shift register 31 (hereinafter, this operation is referred to as “horizontal transfer”). Then, an electric signal (for example, a signal indicating a voltage value) according to the amount of charges read from the first horizontal shift register 31 is output from a first amplifier 33, and the electric signal is AD (analog-digital)-converted into a digital value by an AD converter. The digital value is output to the processing unit 4. In this manner, the first signal S1 is output to the processing unit 4. The first signal S1 is an intensity signal of the measurement light L in each channel, and is spectrum data of the measurement light L.

In the second detection unit 21, charges generated and accumulated in each pixel 10 are transferred to the second horizontal shift register 32 in the second direction D2, and charges of the pixels 10 in each second pixel column 22 are summed forsummed for each column in the second horizontal shift register 32 (vertical transfer). That is, in the light detector 3, signals of the plurality of pixels 10 included in the second pixel column 22 are added (subjected to analog binning) to be an output signal from the second pixel column 22. Therefore, the plurality of pixels 10 included in one second pixel column 22 (channel) can be regarded as constituting one pixel.

Subsequently, the charges summed forsummed for each column in the second horizontal shift register 32 are sequentially read from the second horizontal shift register 32 (“horizontal transfer”). Then, an electric signal (for example, a signal indicating a voltage value) according to the amount of charges read from the second horizontal shift register 32 is output from a second amplifier 34, and the electric signal is AD-converted into a digital value by an AD converter. The digital value is output to the processing unit 4. In this manner, the second signal S2 is output to the processing unit 4. The second signal S2 is an intensity signal of the measurement light L in each channel, and is spectrum data of the measurement light L.

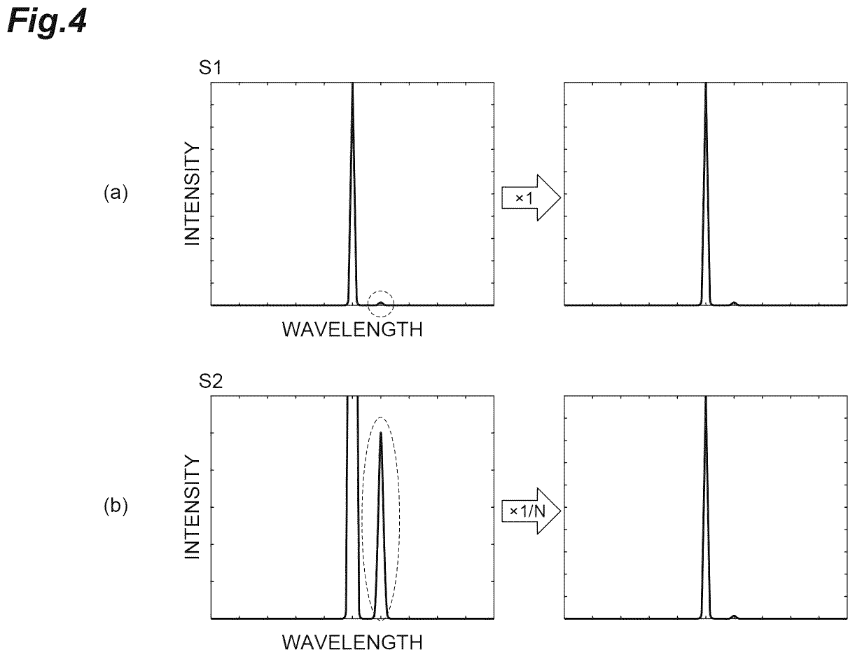

As illustrated in FIGS. 4(a) and 4(b), the first signal S1 and the second signal S2 have a constant multiple relationship. For example, on the left sides of FIGS. 4(a) and 4(b), examples of the first signal S1 and the second signal S2 are illustrated. On the right side of FIG. 4(a), a signal obtained by multiplying the intensity of the first signal S1 by one (that is, the first signal S1) is illustrated. On the right side of FIG. 4(b), a signal obtained by multiplying the intensity of the second signal S2 by (1/N) (normalized second signal S2) is illustrated. N corresponds to a ratio of the second exposure time to the first exposure time. As illustrated in FIGS. 4(a) and 4(b), the first signal S1 corresponds to a signal obtained by multiplying the second signal S2 by (1/N). In the following noise detection method, the normalized second signal S2 is used.

### [Noise Detection Method]

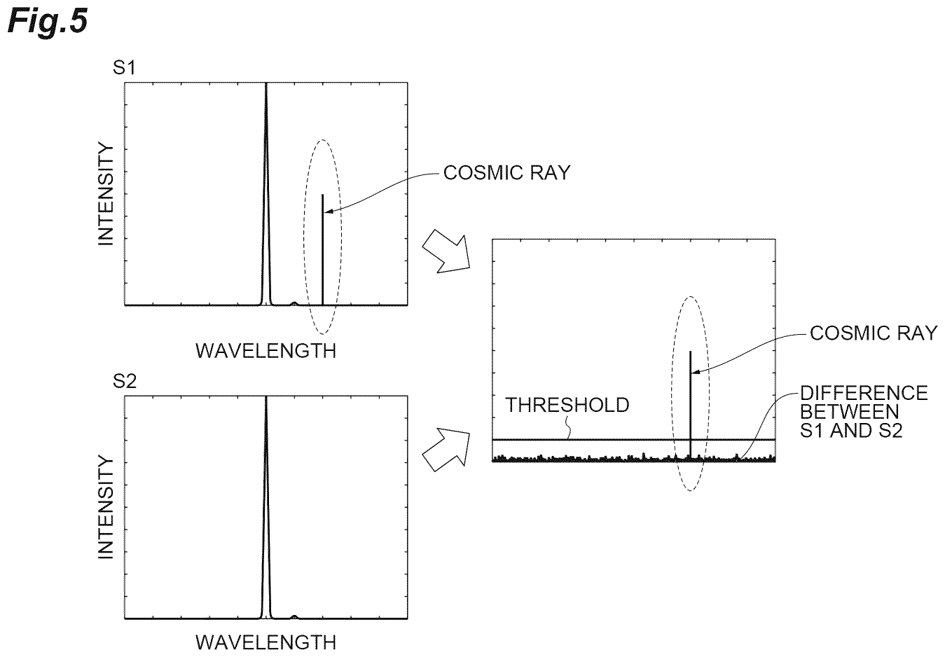

Hereinafter, a noise detection operation (detection method) in the spectrometer 1 will be described. The following noise detection operation is executed by the processing unit 4 based on data (the first signal S1 and the second signal S2) output from the light detector 3. Noise to be detected is noise generated suddenly, for example, noise caused by a cosmic ray. When a cosmic ray is incident on a detection region of the light detector 3, as indicated by a broken line in the upper left graph of FIG. 5, the intensity of the first signal S1 or the second signal S2 in a channel on which the cosmic ray is incident steeply increases.

As a method for detecting such noise, the following method is conceivable. Since a probability that a cosmic ray is incident on the light detector 3 in a certain period is low, and the cosmic ray has a size corresponding to one or several pixels 10 and is extremely small, it is considered that noise caused by the cosmic ray is detected by only one of the first detection unit 11 and the second detection unit 21 (FIG. 3). Therefore, it is considered that noise caused by the cosmic ray can be detected by calculating an intensity difference between the first signal S1 and the second signal S2 in the same channel and monitoring symmetry of two pieces of spectral data. Note that, since detection of such noise is preferably performed in real time, detection performed by simple processing with as little calculation load as possible is required.

For example, in the example of FIG. 5, as indicated by a broken line, the first signal S1 includes noise caused by a cosmic ray. In this case, as illustrated in FIG. 5, it is considered that noise caused by a cosmic ray can be detected by calculating a difference between the first signal S1 and the second signal S2 for each channel (wavelength) and comparing the difference with a predetermined threshold. That is, it can be determined that no noise is included when the difference is less than the threshold, and it can be determined that noise is included when the difference is equal to or more than the threshold. The threshold can be set to a constant value, for example, larger than readout noise and dark current noise (that is, sensor-derived noise) of the sensor (light detector 3).

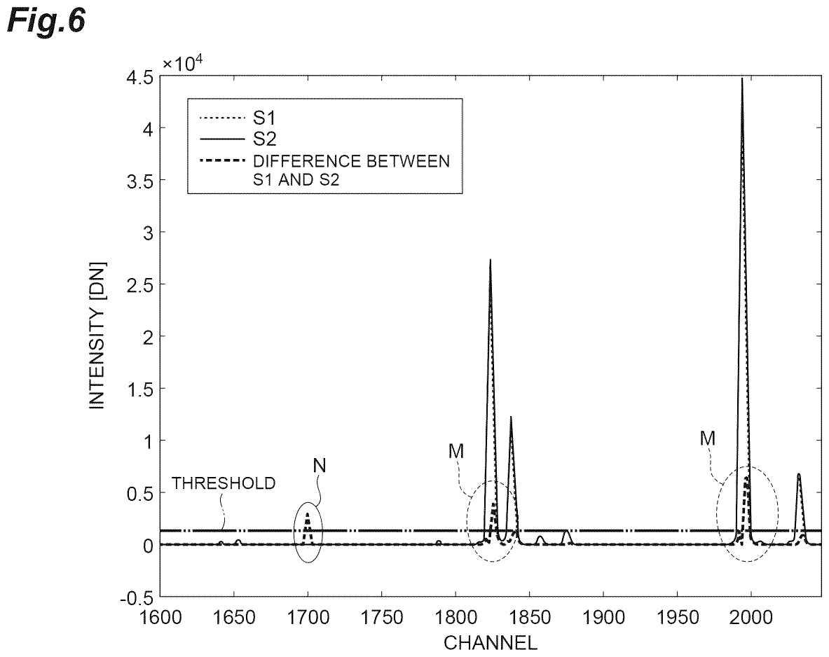

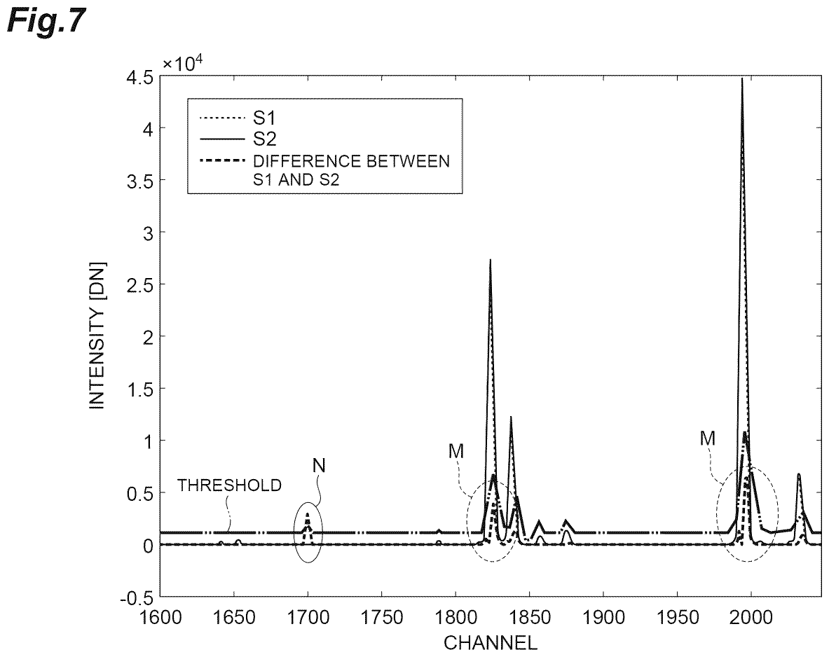

However, the present inventors have found that there is a possibility that erroneous detection occurs in the method and noise cannot be detected accurately. For example, in the example illustrated in FIG. 6, a channel including noise caused by a cosmic ray is indicated by a reference sign N. In this example, a difference between the first signal S1 and the second signal S2 is larger than the threshold in the channel in which noise caused by a cosmic ray is generated. On the other hand, a cosmic ray is not incident on the two channels indicated by a reference sign M, but the difference is larger than the threshold also in these channels. In this case, it is erroneously detected that a signal of the channel also includes noise. In the graph of FIG. 6, a unit “DN” of an intensity on the vertical axis represents a count value. The same applies to FIGS. 7 to 9 described later.

Therefore, in the noise detection method of the present embodiment, a threshold is set for each channel based on the first signal S1 and the second signal S2. That is, instead of setting the threshold to a constant value regardless of a channel as in the method described above, the threshold is (dynamically) set for each channel according to the first signal S1 and the second signal S2. As a specific noise detection operation, the processing unit 4 sets a threshold for each channel, and identifies (detects) a channel in which noise is included in the first signal S1 or the second signal S2 based on the threshold and a difference between the first signal S1 and the second signal S2 in each channel.

First, a first method of the noise detection method of the present embodiment will be described. In the first method, a threshold is set for each channel based on the magnitudes of the first signal S1 and the second signal S2 in the channel. Specifically, in this example, σ represented by the following formula (1) is calculated for each channel, and the threshold is set based on δ. In this case, a value obtained by multiplying δ by a predetermined coefficient K may be used as the threshold, and for example, 5σ (the coefficient K is 5) may be set as the threshold. Note that the coefficient K by which σ is multiplied is not limited to 5, and may be any positive value larger than 1.

$$\begin{matrix}[ Mathematical Formula 1 ] & \\ σ = \sqrt{{σ}_{1 a}^{2} + {σ}_{1 b}^{2} + {σ}_{2 a}^{2} + {σ}_{2 b}^{2}} & ( 1 )\end{matrix}$$

In the formula (1), σ₁ₐ corresponds to readout noise and dark current noise of the first signal S1 (first detection unit 11). σ_{1b} corresponds to shot noise of the first signal S1 (first detection unit 11). The shot noise is noise that increases in proportion to the magnitude of a detection signal, and σ_{1b} is proportional to the magnitude of the first signal S1. σ₂ₐ corresponds to readout noise and dark current noise of the second signal S2 (second detection unit 21). σ_{2b} corresponds to shot noise of the second signal S2 (second detection unit 21). 026 is proportional to the magnitude of the second signal S2. The readout noise and the dark current noise are noise derived from the sensor, and the shot noise is noise derived from the measurement light L.

FIG. 7 illustrates an example of a case where the threshold is set by the first method. In this example, the first signal S1 and the second signal S2 are set similarly to the example of FIG. 6. Also in this example, a difference between the first signal S1 and the second signal S2 is larger than the threshold in a channel (N) in which noise caused by a cosmic ray is generated. In addition, the difference is smaller than the threshold in two channels (M) on which a cosmic ray is not incident. In this case, it can be correctly detected that the signal of the channel does not include noise. As described above, according to the first method, for example, noise can be detected accurately as compared with a case where the threshold is set to a constant value regardless of a channel.

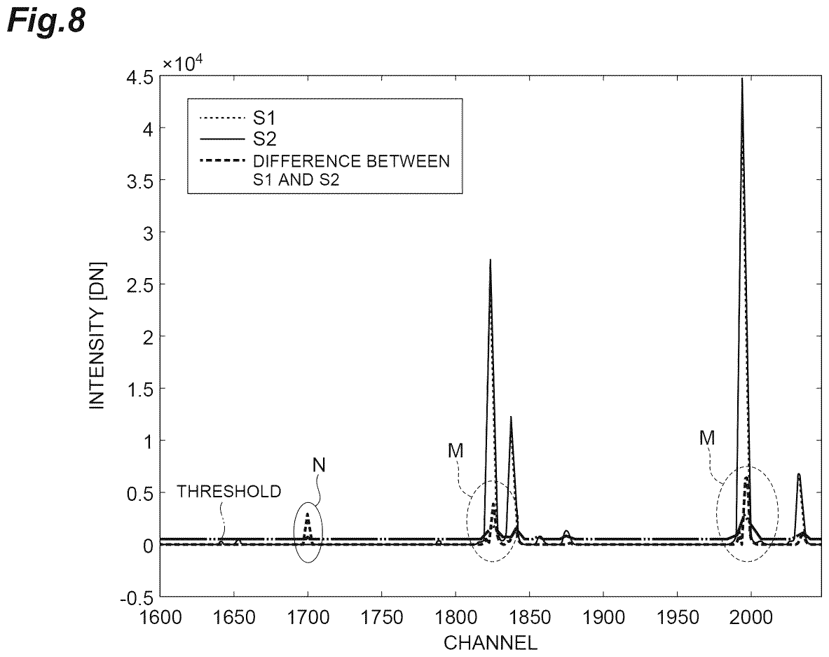

The present inventors have further found that, in a case where the first method is used, noise can be detected more accurately than the above-described case where the threshold is set to a constant value, but erroneous detection may occur. For example, in the example illustrated in FIG. 8, a difference between the first signal S1 and the second signal S2 is larger than the threshold in a channel (N) in which noise caused by a cosmic ray is generated, but the difference is larger than the threshold also in two channels (M) on which the cosmic ray is not incident. In this case, it is erroneously detected that the signal of the channel also includes noise.

Therefore, in a second method of the noise detection method of the present embodiment, a threshold is set for each channel based on the magnitudes of the first signal S1 and the second signal S2 in the channel and a channel proximate to the channel. Hereinafter, the second method will be described.

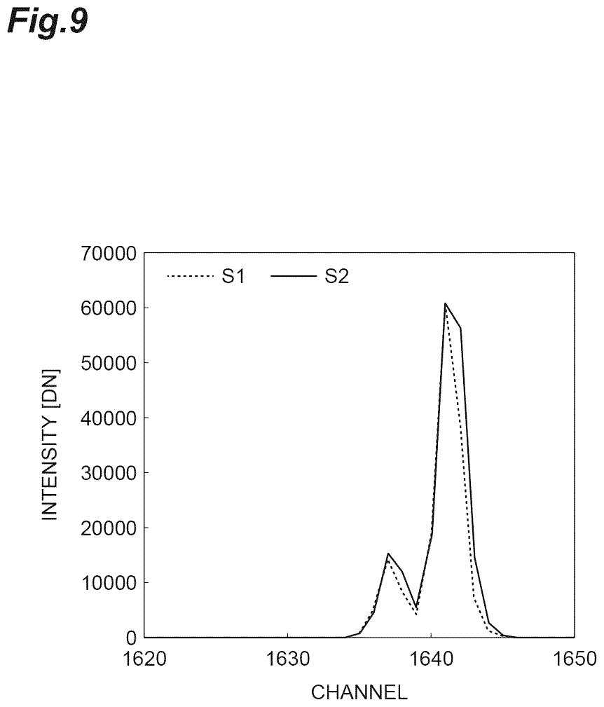

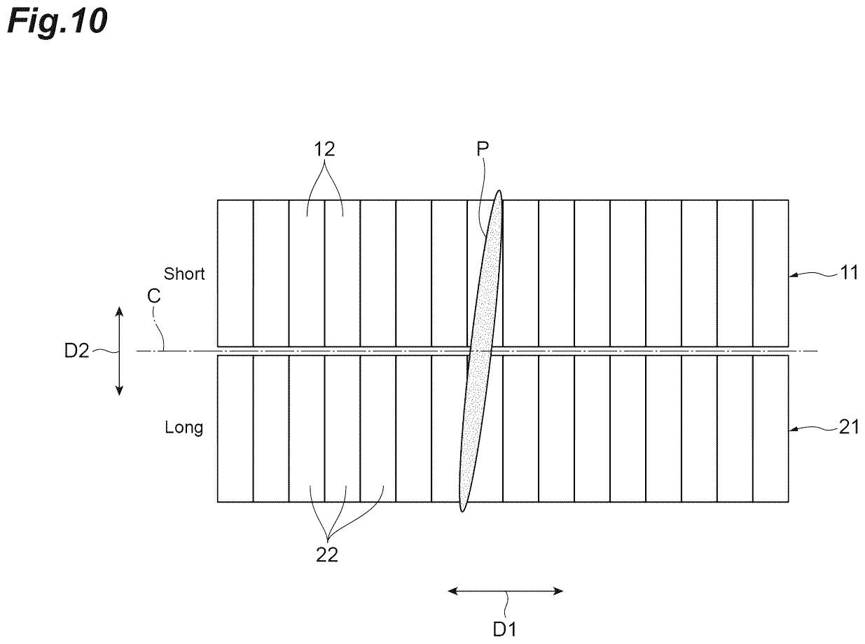

First, optical distortion that can occur in the first signal S1 and the second signal S2 will be described with reference to FIGS. 9 and 10. Ideally, the first signal S1 and the second signal S2 should coincide with each other, but actually, as illustrated in FIG. 9, there may be a shift between the first signal S1 and the second signal S2. This is considered to be because, as illustrated in FIG. 10, a spectral image P incident on a detection region (the first detection unit 11 and the second detection unit 21) of the light detector 3 is inclined with respect to the second direction D2 due to optical distortion and is asymmetric with respect to the center line C. That is, it is considered that the spectral image P having a certain wavelength is formed across a plurality of channels. Such optical distortion can occur due to, for example, an attachment error (positional shift) between the spectroscopic unit 2 and the light detector 3.

The shift between the first signal S1 and the second signal S2 due to optical distortion is usually smaller than the width of several channels (for example, 2 to 3 channels), and in many cases, smaller than the width of one channel (that is, at a subchannel level). Due to such a shift, it is considered that a difference between the first signal S1 and the second signal S2 may be larger than the threshold also in the two channels (M) on which a cosmic ray is not incident as in the above-described examples of FIGS. 6 and 8. Therefore, in the second method of the noise detection method of the present embodiment, a threshold is set for each channel in consideration of an influence of optical distortion.

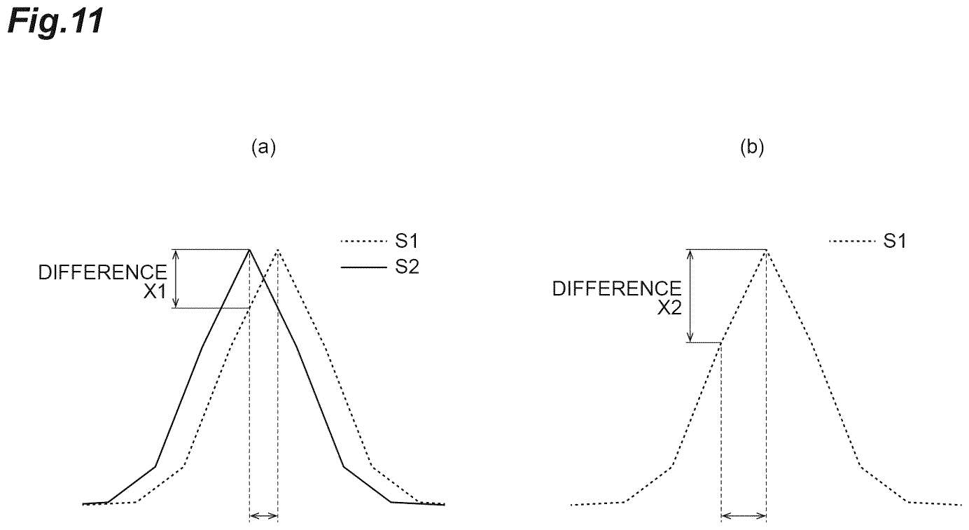

The second method will be described with reference to FIGS. 11 to 15. The second method is based on an idea that a difference X1 between the first signal S1 and the second signal S2 in a certain channel illustrated in FIG. 11(a) should be smaller than a difference X2 between the first signal S1 in the channel and the first signal S1 in a proximity channel proximate to the channel illustrated in FIG. 11(b). This is because, in a case where the difference X1 is larger than the difference X2, such a shift is not explained by the optical distortion described above.

The proximity channel is, for example, a channel adjacent to the channel, but may be any channel as long as it is proximate to the channel, and may be a channel within a range from a channel immediately adjacent to the channel (a channel one channel away from the channel) to a channel five channels away from the channel. The proximity channel may be a channel two channels away from the channel, or may be a channel three channels away from the channel. That is, the proximity channel may be a channel within a range from a channel immediately adjacent to the channel to a channel three channels away from the channel.

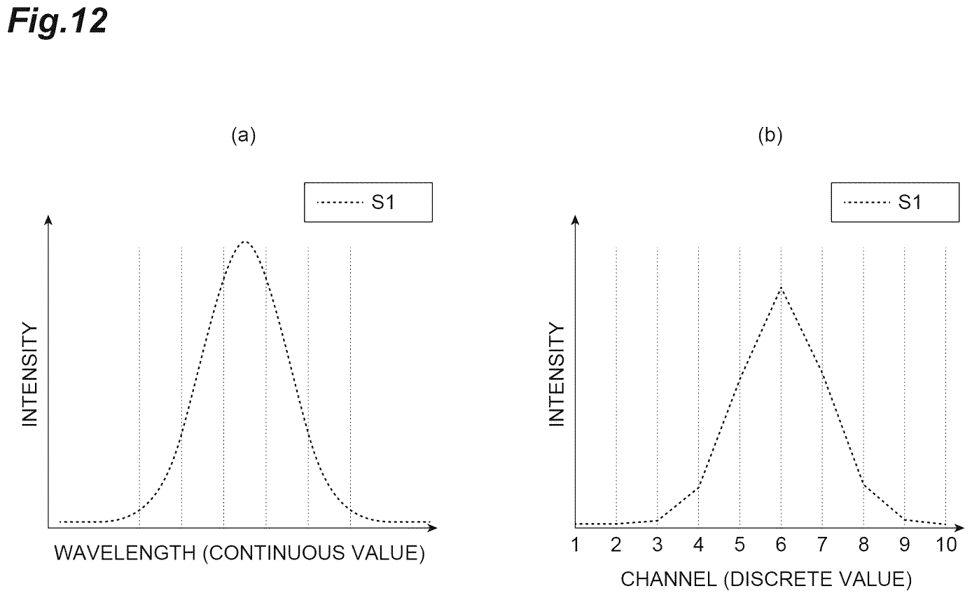

As illustrated in FIGS. 12(a) and 12(b), in the second method of the noise detection method of the present embodiment, first, the first signal S1 and the second signal S2 are discretized from a continuous value to a discrete value for each channel. Note that FIGS. 12(a) and 12(b) illustrate only the first signal S1, but the second signal S2 is similarly discretized.

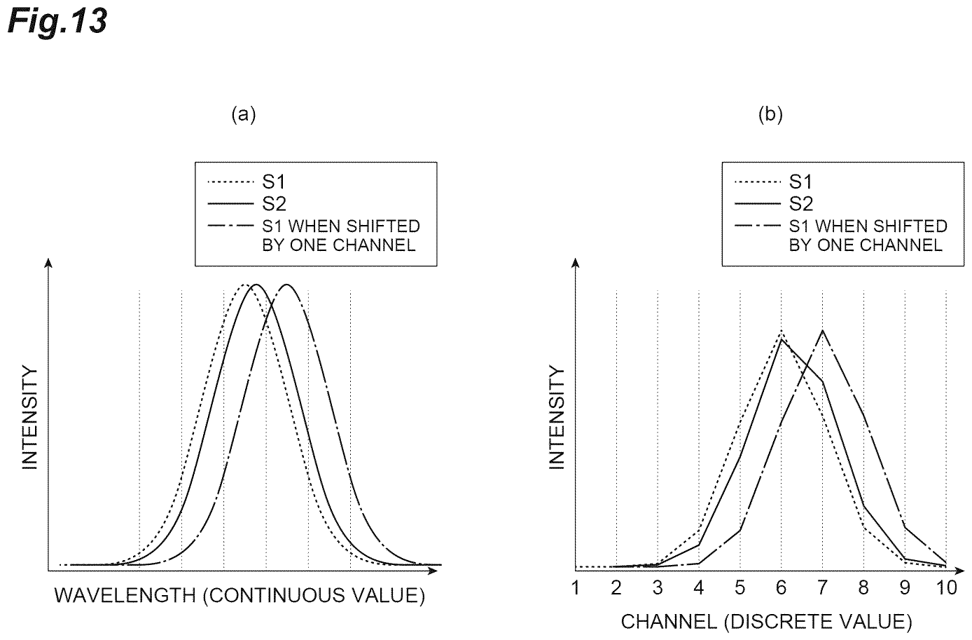

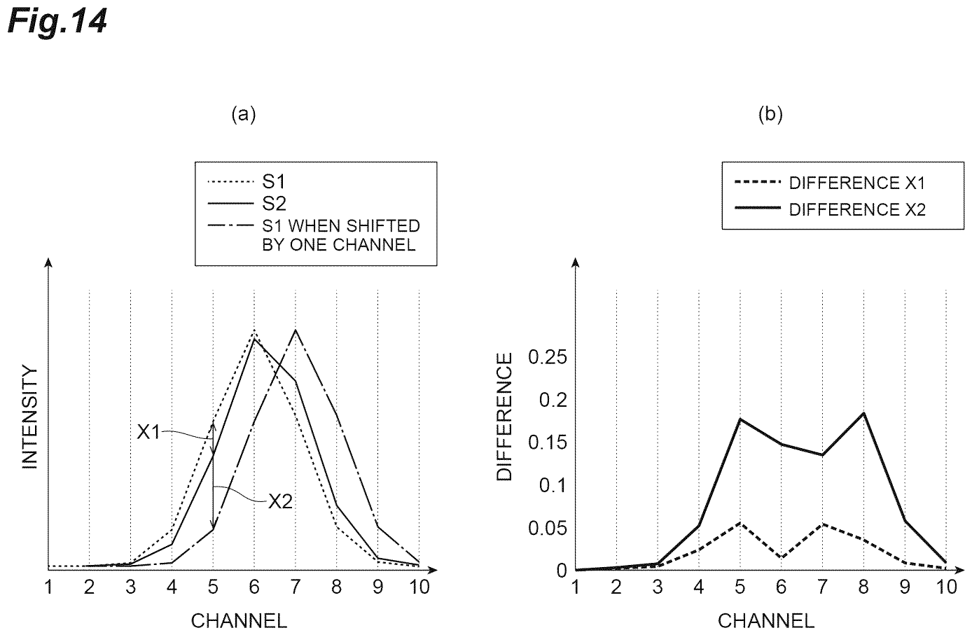

FIGS. 13(a) and 13(b) exemplify the first signal S1 and the second signal S2 in a case where the first signal S1 and the second signal S2 are shifted from each other by a ¼ channel, and the first signal S1 (the first signal S1 in a proximity channel) when shifted by one channel. FIG. 14(a) corresponds to FIG. 13(b). FIG. 14(b) illustrates a difference X1 between the first signal S1 and the second signal S2 in each channel in the example of FIG. 14(a). In addition, FIG. 14(b) illustrates, for each channel, a difference X2 between the first signal S1 in the channel and the first signal S1 in a case where the first signal S1 is shifted from the channel by one channel. As illustrated in FIG. 14(b), the difference X1 is smaller than the difference X2 in each channel.

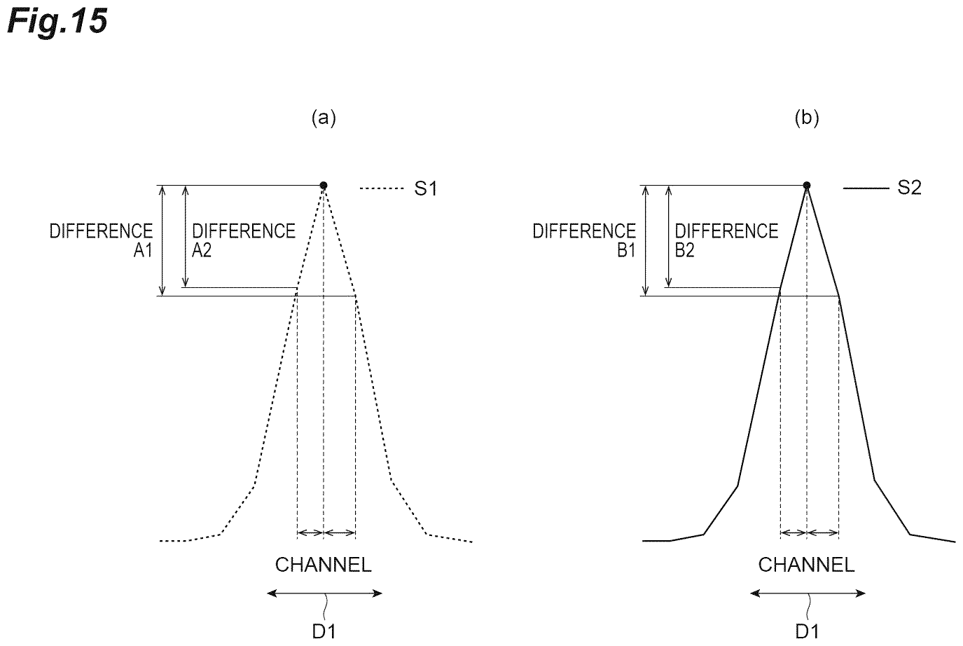

In the second method of the noise detection method of the present embodiment, at least one of the differences A1, A2, B1, and B2 (difference values) illustrated in FIGS. 15(a) and 15(b) is used for setting a threshold. The difference A1 is a difference between a value of the first signal S1 in a target channel and a value of the first signal S1 in a proximity channel (first proximity channel) proximate to the channel on one side (right side in FIG. 15) in the first direction D1. The difference A2 is a difference between a value of the first signal S1 in the target channel and a value of the first signal S1 in a proximity channel proximate to the channel on the other side (left side in FIG. 15) in the first direction D1. The difference B1 is a difference between a value of the second signal S2 in the target channel and a value of the second signal S2 in a proximity channel proximate to the channel on one side in the first direction D1. The difference B2 is a difference between a value of the second signal S2 in the target channel and a value of the second signal S2 in a proximity channel (second proximity channel) proximate to the channel on the other side in the first direction D1.

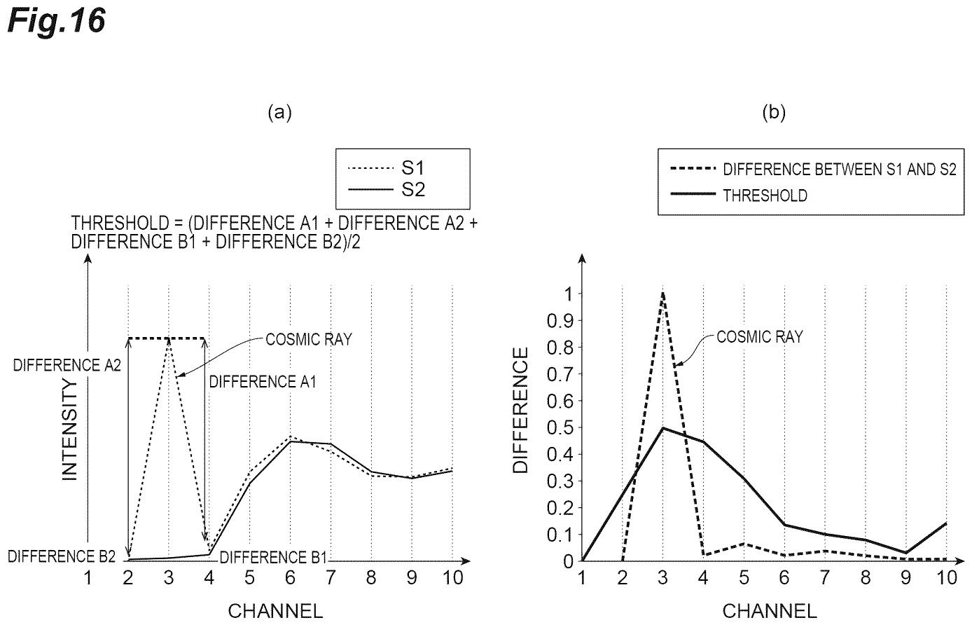

FIGS. 16(a) and 16(b) are diagrams for explaining a first example of the second method. In the first example, the threshold is set to an average value of the differences A1, A2, B1, and B2 (difference values). That is, the threshold is set to (difference A1+difference A2+difference B1+difference B2)/4. FIG. 16(a) illustrates examples of the first signal S1 and the second signal S2 and each difference in this case. As illustrated in FIG. 16(b), by setting the threshold as in the first example, noise caused by a cosmic ray can be detected accurately.

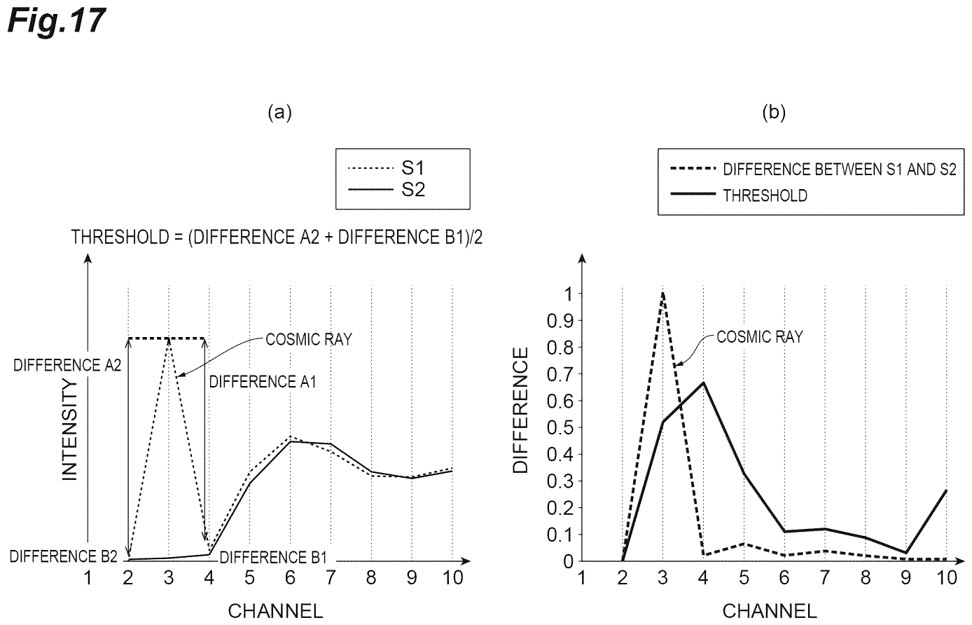

FIGS. 17(a) and 17(b) are diagrams for explaining a second example of the second method. In the second example, the threshold is set to an average value of the differences A2 and B1 (difference values). That is, the threshold is set to (difference A2+difference B1)/2. FIG. 17(a) corresponds to FIG. 16(a). As illustrated in FIG. 17(b), also when the threshold is set as in the second example, noise caused by a cosmic ray can be detected accurately.

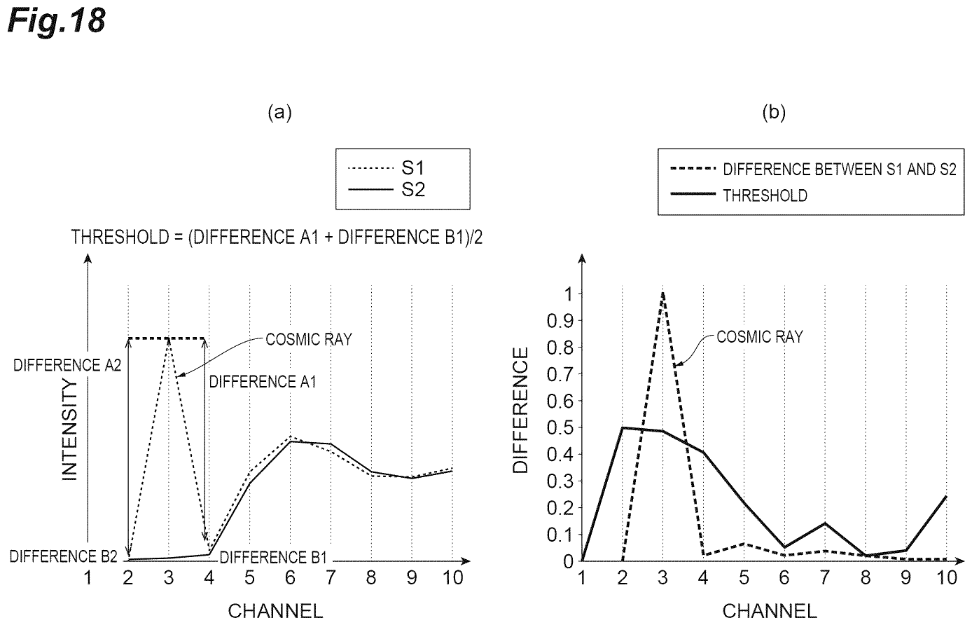

FIGS. 18(a) and 18(b) are diagrams for explaining a third example of the second method. In the third example, the threshold is set to an average value of the differences A1 and B1 (difference values). That is, the threshold is set to (difference A1+difference B1)/2. FIG. 18(a) corresponds to FIG. 16(a). As illustrated in FIG. 18(b), also when the threshold is set as in the third example, noise caused by a cosmic ray can be detected accurately.

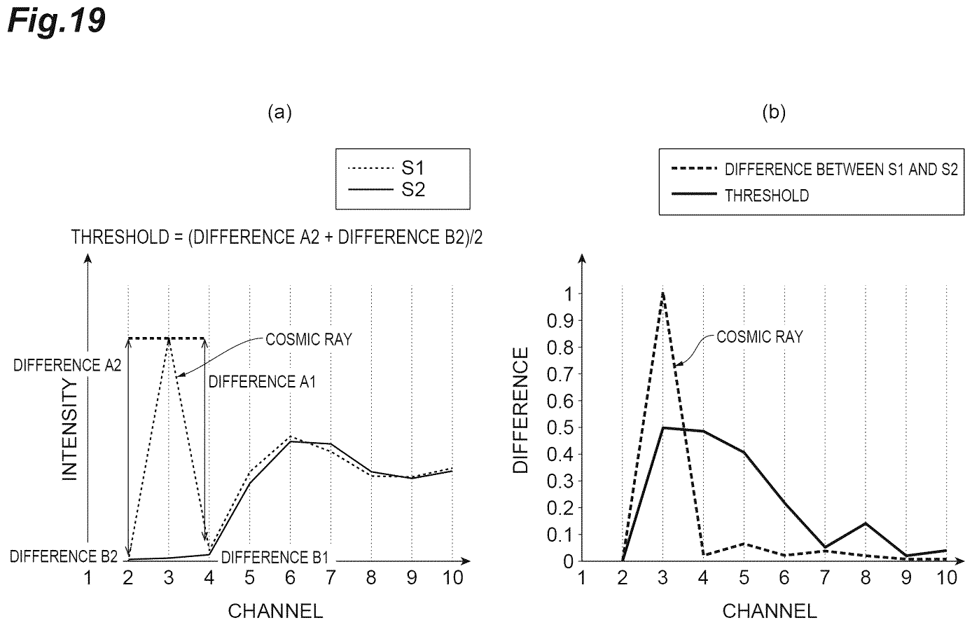

FIGS. 19(a) and 19(b) are diagrams for explaining a fourth example of the second method. In the fourth example, the threshold is set to an average value of the differences A2 and B2 (difference values). That is, the threshold is set to (difference A2+difference B2)/2. FIG. 19(a) corresponds to FIG. 16(a). As illustrated in FIG. 19(b), also when the threshold is set as in the fourth example, noise caused by a cosmic ray can be detected accurately.

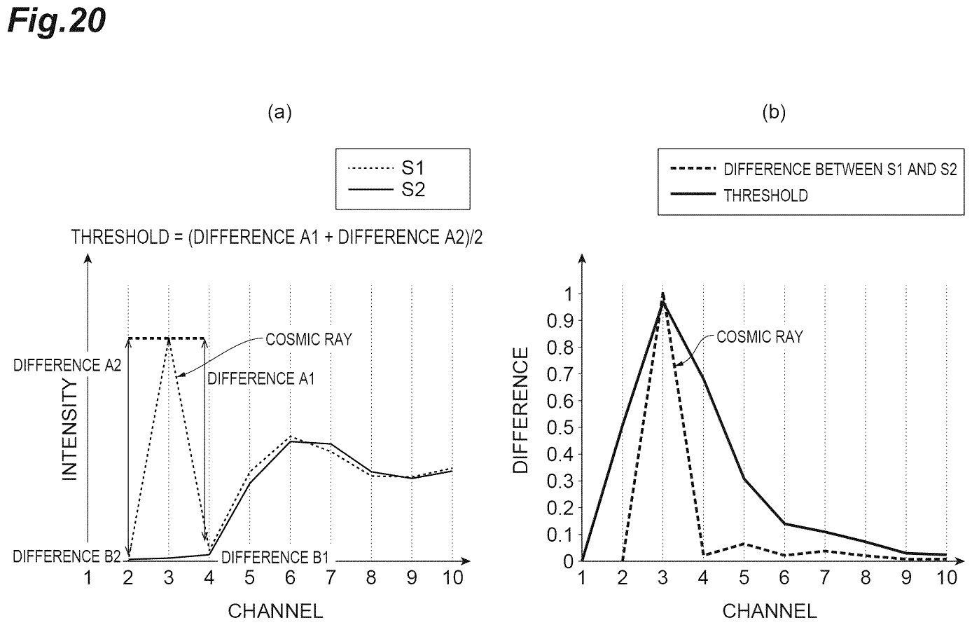

FIGS. 20(a) and 20(b) are diagrams for explaining a comparative example. In the comparative example, the threshold is set to an average value of the differences A1 and A2 (difference values). That is, the threshold is set to (difference A1+difference A2)/2. FIG. 20(a) corresponds to FIG. 16(a). In the case of the comparative example, there is a possibility that noise caused by a cosmic ray cannot be detected accurately. This is considered to be because, as described above, since there is a high possibility that a cosmic ray is detected by only one of the first detection unit 11 and the second detection unit 21, when the threshold is set based on the differences A1 and A2 calculated only from the first signal S1, noise cannot be detected when noise is included in the second signal S2.

As described above, by setting the threshold based on the difference value (difference A1, A2, B1, or B2), an influence of noise caused by a cosmic ray on setting of the threshold can be alleviated, and the noise caused by the cosmic ray can be detected accurately. In addition, as described above, by setting the threshold based on a difference value including at least one of the differences A1 and A2 and one of the differences B1 and B2, noise caused by a cosmic ray can be detected accurately. In particular, as in the first example, by setting the threshold based on the four differences A1, A2, B1, and B2, noise caused by a cosmic ray can be detected more accurately.

When two differences are selected as the difference value, a combination of the difference A1 and the difference B2 and a combination of the difference A2 and the difference B1 (second example, FIG. 17) are more preferable than a combination of the difference A1 and the difference B1 (third example, FIG. 18) and a combination of the difference A2 and the difference B2 (fourth example, FIG. 19). This is because, as illustrated in FIG. 10, since the spectral image P is asymmetric with respect to the center line C due to optical distortion, it is preferable to combine a difference on one side and a difference on the other side in the first direction D1. For this reason, while the threshold is appropriately set in each channel in the second example of FIG. 17, a difference between the first signal S1 and the second signal S2 is considered to be a value proximate to the threshold in the channel 8 in the third example of FIG. 18 and in the channels 7 and 9 in the fourth example of FIG. 19.

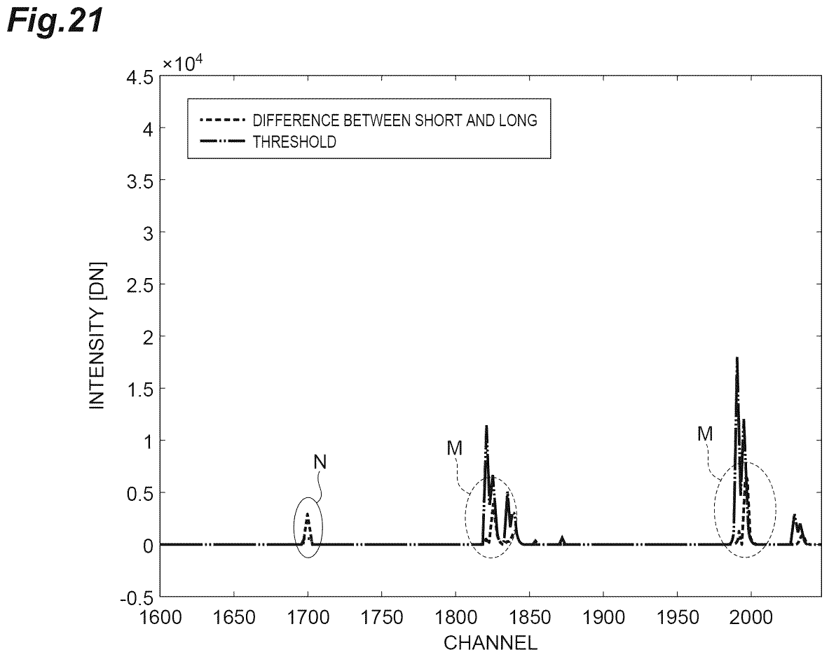

FIG. 21 is a graph illustrating an example in a case where the first method and the second method are combined. In this example, the first method and the second method are combined, and the threshold is set based on K×σ and the average value of the differences A1, A2, B1, and B2 described above. For example, the threshold may be set to a value obtained by adding K×σ and the average value of the differences A1, A2, B1, and B2. In the example of FIG. 21, a difference between the first signal S1 and the second signal S2 is larger than the threshold in a channel (N) in which noise caused by a cosmic ray is generated. In addition, the difference is smaller than the threshold in two channels (M) on which a cosmic ray is not incident. As described above, also when the first method and the second method are combined, noise caused by a cosmic ray can be detected accurately.

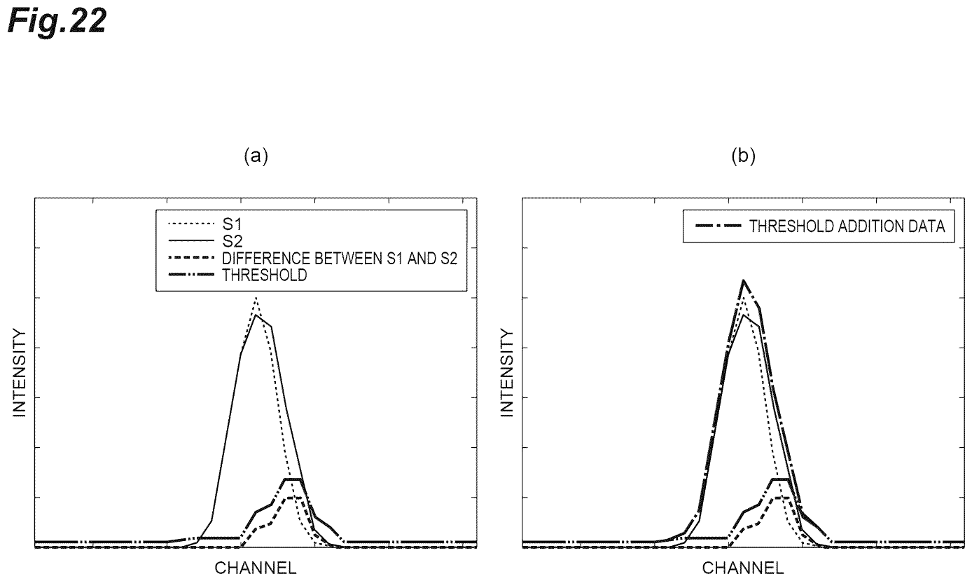

FIGS. 22(a) and 22(b) are diagrams for explaining threshold addition data. At the time of noise detection, as illustrated in FIG. 22(a), a difference between the first signal S1 and the second signal S2 may be calculated for each channel, and the calculated difference may be compared with the threshold. That is, for each channel, by comparing a difference between the first signal S1 and the second signal S2 in the channel with the threshold, the processing unit 4 may identify that noise is included in the first signal S1 or the second signal S2 in the channel. More specifically, the processing unit 4 may identify that noise is included in the first signal S1 or the second signal S2 in the channel when the difference is larger than the threshold, and may determine that noise is not included in the first signal S1 or the second signal S2 in the channel when the difference is equal to or smaller than the threshold.

Alternatively, as illustrated in FIG. 22(b), by creating threshold addition data obtained by adding the threshold to a smaller value of the first signal S1 and the second signal S2 for each channel, and comparing the first signal S1 and the second signal S2 with the threshold addition data, the processing unit 4 may identify a channel in which noise is included in the first signal S1 or the second signal S2. More specifically, the processing unit 4 may identify that noise is included in the first signal S1 or the second signal S2 in the channel when a larger value of the first signal S1 and the second signal S2 is larger than the threshold addition data, and may determine that noise is not included in the first signal S1 or the second signal S2 in the channel when the larger value of the first signal S1 and the second signal S2 is equal to or smaller than the threshold addition data. By using the threshold addition data, it is possible to set a threshold for the first signal S1 and the second signal S2 instead of a difference between the first signal S1 and the second signal S2.

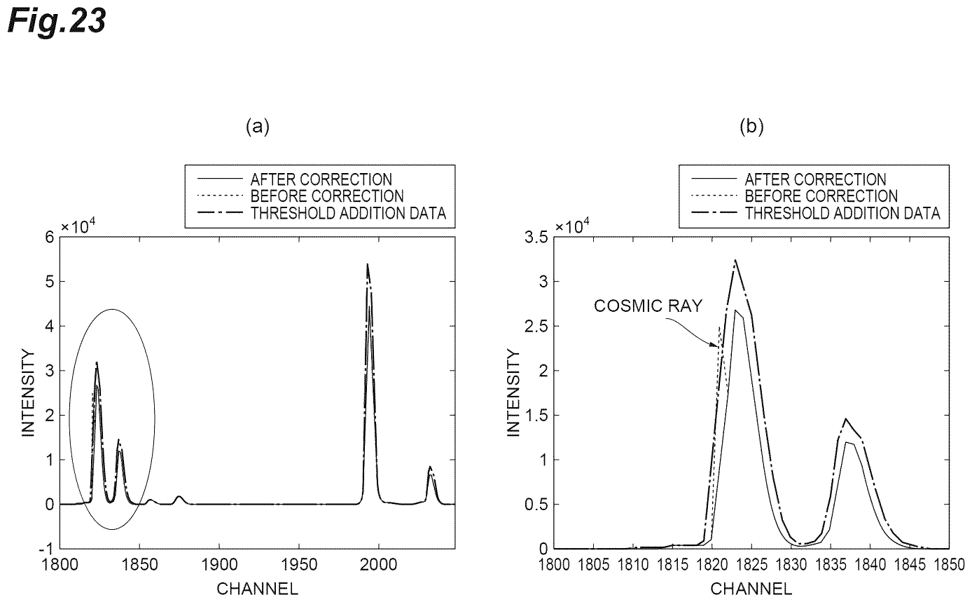

FIGS. 23(a) and 23(b) are graphs illustrating examples of an application result of the second method. In FIG. 23(b), a portion indicated by an ellipse in FIG. 23(a) is enlarged. In this example, as in the first example described above, the threshold is set to an average value of the differences A1, A2, B1, and B2. In this example, noise caused by a cosmic ray is given to actual measurement data of the second signal S2 by simulation. Data described as “before correction” is a larger one of the first signal S1 and the second signal S2, and is the second signal S2 in this example.

As illustrated in FIG. 23(b), the second signal S2 is larger than the threshold addition data in a channel including noise caused by a cosmic ray, and the second signal S2 is smaller than the threshold addition data in the other channels not including the cosmic ray. As described above, by using the second method, noise caused by a cosmic ray can be detected accurately.

In addition, as illustrated in FIG. 23(b), after a channel including noise is identified, a value of the channel may be interpolated by values of channels on both sides of the channel. In FIG. 23(b), the interpolated data is indicated as “after correction”. For example, the value of the channel may be interpolated by a line segment that smoothly connects values of channels on both sides of the channel. That is, the processing unit 4 may interpolate a value of a channel identified as including noise in the first signal S1 or the second signal S2 based on values of channels on both sides of the channel.

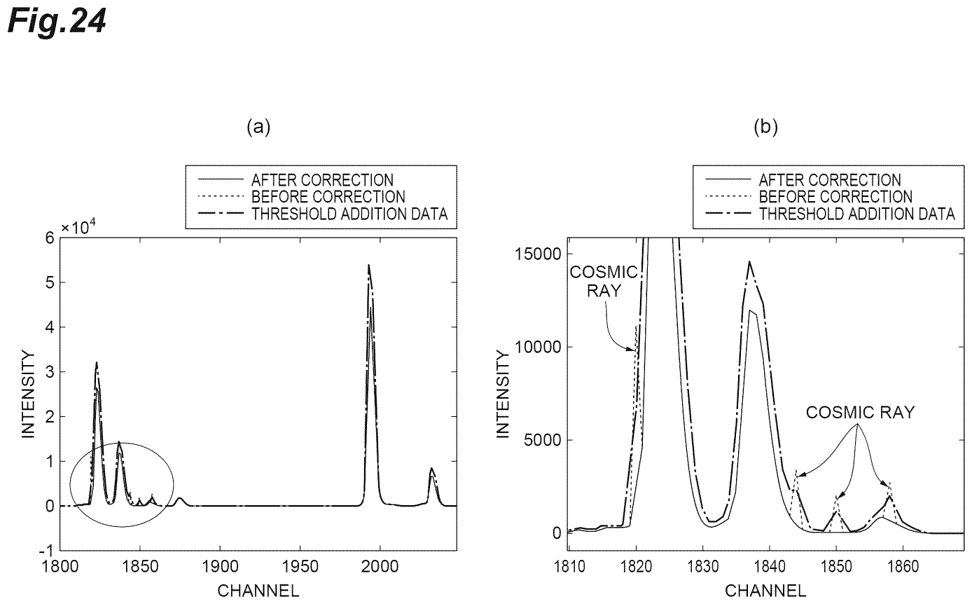

FIGS. 24(a) and 24(b) are graphs illustrating another example of the application result of the second method. In FIG. 24(b), a portion indicated by an ellipse in FIG. 24(a) is enlarged. As illustrated in FIG. 24(b), also from this example, it can be seen that noise caused by a cosmic ray can be detected accurately by using the second method. In addition, in the example of FIG. 24, steeper noise is given than in the example of FIG. 23, but it can be seen that such noise can also be detected favorably. Therefore, the second method can be suitably used also in a case where the measurement light L having a broad spectrum is detected and in a case where a cosmic ray has a large luminance.

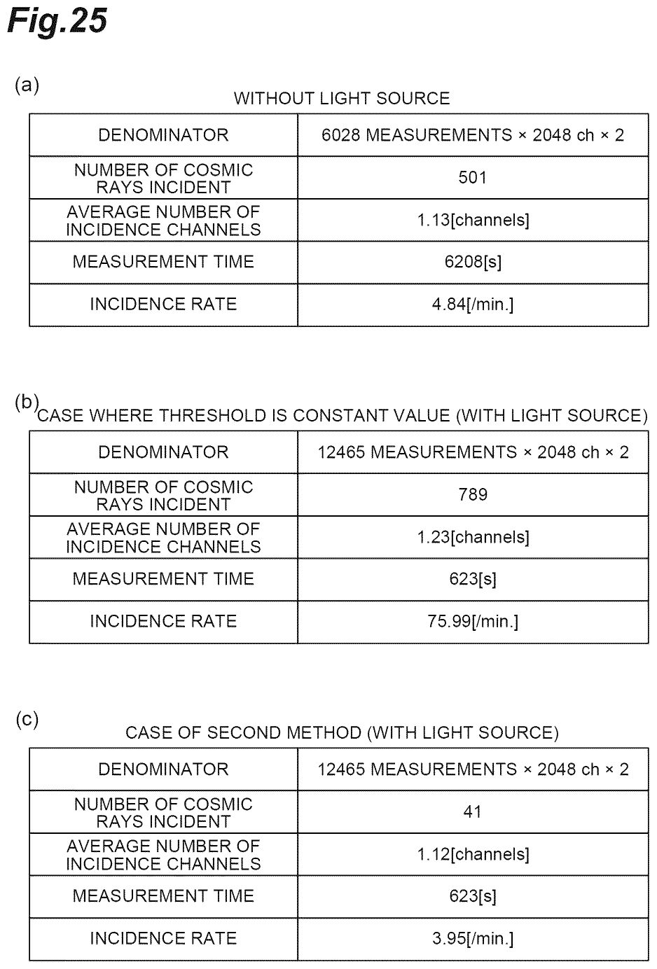

FIGS. 25(a), 25(b), and 25(c) are tables for explaining actual measurement results. FIG. 25(a) illustrates an actual measurement result of measurement performed without a light source (in a state where light is not incident on the light detector 3) while noise is detected with a constant threshold. In the experiment of FIG. 25(a), the number of channels was set to 2048, and measurement was performed 6208 times. The number of cosmic rays detected was 501, and an average value of the number of channels on which the cosmic rays were incident was 1.13. A measurement time was 6208 seconds, and an incidence rate of the cosmic rays was 4.84/min.

FIG. 25(b) illustrates an actual measurement result of measurement performed with a light source (in a state where light is incident on the light detector 3) while noise is detected with a constant threshold. In the experiment of FIG. 25(b), the number of channels was set to 2048, and measurement was performed 12465 times. The number of cosmic rays detected was 789, and an average value of the number of channels on which the cosmic rays were incident was 1.23. A measurement time was 623 seconds, and an incidence rate of the cosmic rays was 75.99/min. In FIG. 25(b), since the incidence rate of the cosmic rays is extremely larger than that in the case of FIG. 25(a), it can be seen that many erroneous detections occur when noise is detected with a constant threshold.

FIG. 25(c) illustrates an actual measurement result of measurement performed with a light source (in a state where light is incident on the light detector 3) while noise is detected by setting a threshold to an average value of the differences A1, A2, B1, and B2 as in the first example of the second method. In the experiment of FIG. 25(c), the number of channels was set to 2048, and measurement was performed 12465 times. The number of cosmic rays detected was 41, and an average value of the number of channels on which the cosmic rays were incident was 1.12. A measurement time was 623 seconds, and an incidence rate of the cosmic rays was 3.95/min. In FIG. 25(c), since the incident rate of the cosmic rays is similar to that in the case of FIG. 25(a), it can be seen that noise caused by the cosmic rays can be detected accurately by using the second method.

### Functions and Effects

In the light detection device 5, the processing unit 4 sets a threshold for each channel, and identifies a channel in which noise is included in the first signal S1 or the second signal S2 based on the threshold and a difference between the first signal S1 and the second signal S2 in each channel. In the first method and the second method described above, the threshold is set for each channel based on the first signal S1 and the second signal S2. In this manner, by setting the threshold for each channel based on the first signal S1 and the second signal S2, noise can be detected accurately as compared with, for example, a case where the threshold is set to a constant value regardless of a channel. Therefore, in the first method and the second method described above, the threshold is set for each channel based on the magnitude of the first signal S1 and the magnitude of the second signal S2 in the channel and/or a channel proximate to the channel. That is, in the first method, the threshold is set for each channel based on the magnitudes of the first signal S1 and the second signal S2 in the channel, and in the second method, the threshold is set for each channel based on the magnitudes of the first signal S1 and the second signal S2 in the channel and a channel proximate to the channel. This makes it possible to detect noise accurately.

In the first method described above, the threshold is set for each channel based on the magnitude of the first signal S1 and the magnitude (shot noise) of the second signal S2 in the channel. As a result, the threshold can be suitably set, and noise can be detected more accurately.

In the second method described above, the threshold is set based on a difference between a value of the first signal S1 in a target channel and a value of the first signal S1 in a proximity channel (first proximity channel) proximate to the channel (a difference A1 or a difference A2), and a difference between a value of the second signal S2 in the channel and a value of the second signal S2 in a proximity channel proximate to the channel (a difference B1 or a difference B2). As a result, the threshold can be suitably set, and noise can be detected more accurately.

In the light detection device 5, by creating threshold addition data obtained by adding the threshold to a smaller value of the first signal S1 and the second signal S2 for each channel, and comparing the first signal S1 and the second signal S2 with the threshold addition data, the processing unit 4 may identify a channel in which noise is included in the first signal S1 or the second signal S2. In this case, noise detection can be suitably performed.

In the light detection device 5, the first signal S1 is one-dimensional data of the measurement light L detected in the first exposure time by the first detection unit 11, and the second signal S2 is one-dimensional data of the measurement light L detected in the second exposure time by the second detection unit 21. The second exposure time is longer than the first exposure time. As a result, a dynamic range can be increased by combining pieces of data having different exposure times (the first signal S1 and the second signal S2).

The processing unit 4 interpolates a value of a channel identified as including noise in the first signal S1 or the second signal S2 based on values of channels on both sides of the channel. As a result, an influence of noise on light detection can be reduced.

In the light detection device 5, the light detector 3 is a CCD light detector including: the first horizontal shift register 31 to which charges generated in the plurality of first pixel columns 12 of the first detection unit 11 are transferred; and the second horizontal shift register 32 to which charges generated in the plurality of second pixel columns 22 of the second detection unit 21 are transferred. As a result, it is possible to avoid an increase in readout noise when charges generated in each pixel 10 are read out.

The spectrometer 1 includes the spectroscopic unit 2 that spectrally disperses the measurement light L, and the light detection device 5 that detects the measurement light L spectrally dispersed by the spectroscopic unit 2 in the first detection unit 11 and the second detection unit 21. According to the spectrometer 1, noise can be detected accurately for the reasons described above.

The noise detection method according to the embodiment includes: a step of outputting the first signal S1 and the second signal S2 using the light detector 3; a step of setting a threshold for each channel; and a step of identifying a channel in which noise is included in the first signal S1 and the second signal S2 based on the threshold in the channel and a difference between the first signal S1 and the second signal S2. In the step of setting a threshold, the threshold is set based on a difference value. The difference value includes a difference between a value of the first signal S1 in a target channel and a value of the first signal S1 in a proximity channel (first proximity channel) proximate to the channel (a difference A1 or a difference A2), and a difference between a value of the second signal S2 in the channel and a value of the second signal S2 in a proximity channel proximate to the channel (a difference B1 or a difference B2). According to this noise detection method, noise can be detected accurately for the reasons described above.

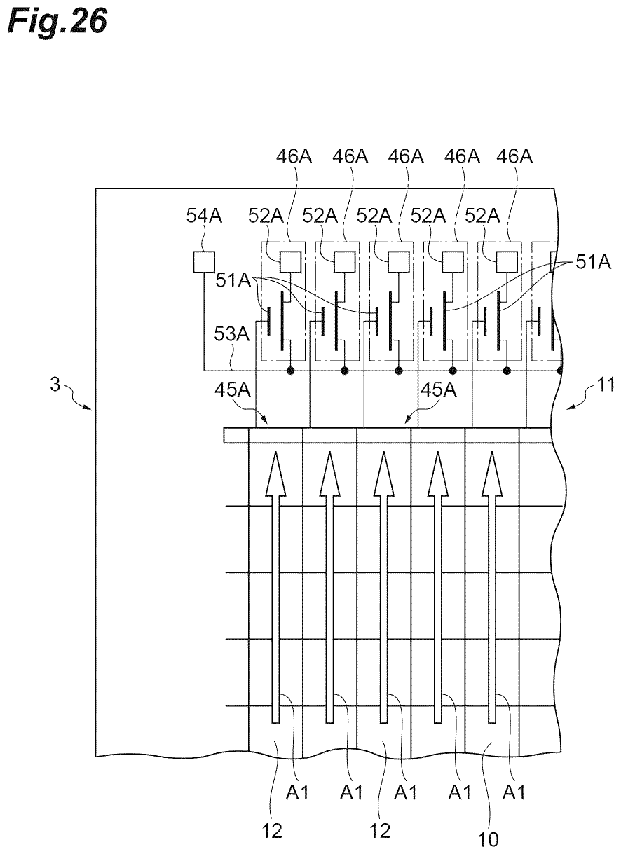

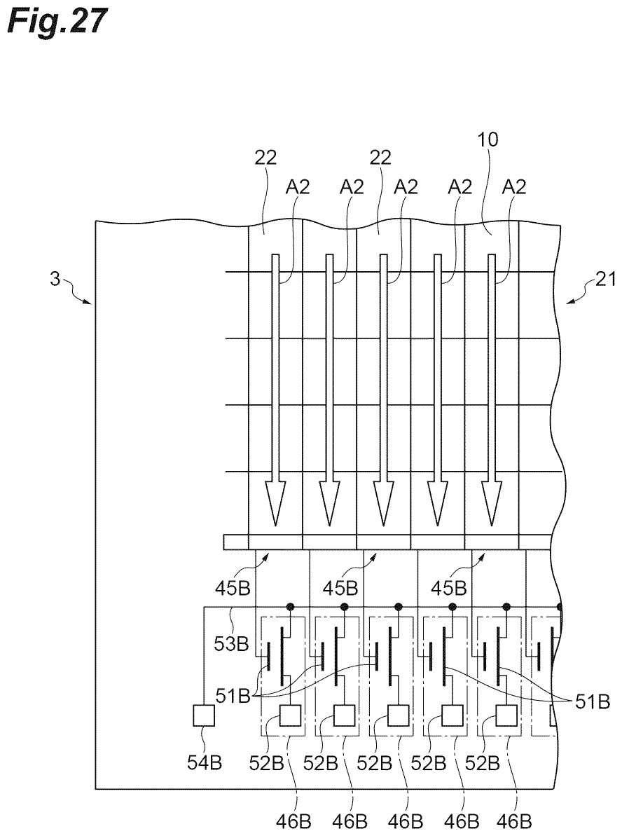

The present disclosure is not limited to the above embodiment. For example, as illustrated in FIGS. 26 and 27, the light detector 3 may be a CCD light detector including a plurality of first accumulation units 45A, a plurality of second accumulation units 45B, a plurality of first readout units 46A, and a plurality of second readout units 46B. Charges generated in the plurality of first pixel columns 12 of the first detection unit 11 are accumulated in the plurality of first accumulation units 45A (arrow A1). Charges generated in the plurality of second pixel columns 22 of the second detection unit 21 are accumulated in the plurality of second accumulation units 45B (arrow A2). The plurality of first readout units 46A are electrically connected to the plurality of first accumulation units 45A, respectively, and output electric signals corresponding to the magnitude of charges accumulated in the plurality of first accumulation units 45A. The plurality of second readout units 46B are electrically connected to the plurality of second accumulation units 45B, respectively, and output electric signals corresponding to the magnitude of charges accumulated in the plurality of second accumulation units 45B. Also in this case, it is possible to avoid an increase in readout noise when charges generated in each pixel 10 are read out. FIG. 26 illustrates a transistor 51A and a bonding pad 52A constituting the first readout unit 46A. The transistor 51A is electrically connected to a bonding pad 54A via wiring 53A. FIG. 27 illustrates a transistor 51B and a bonding pad 52B constituting the second readout unit 46B. The transistor 51B is electrically connected to a bonding pad 54B via wiring 53B.

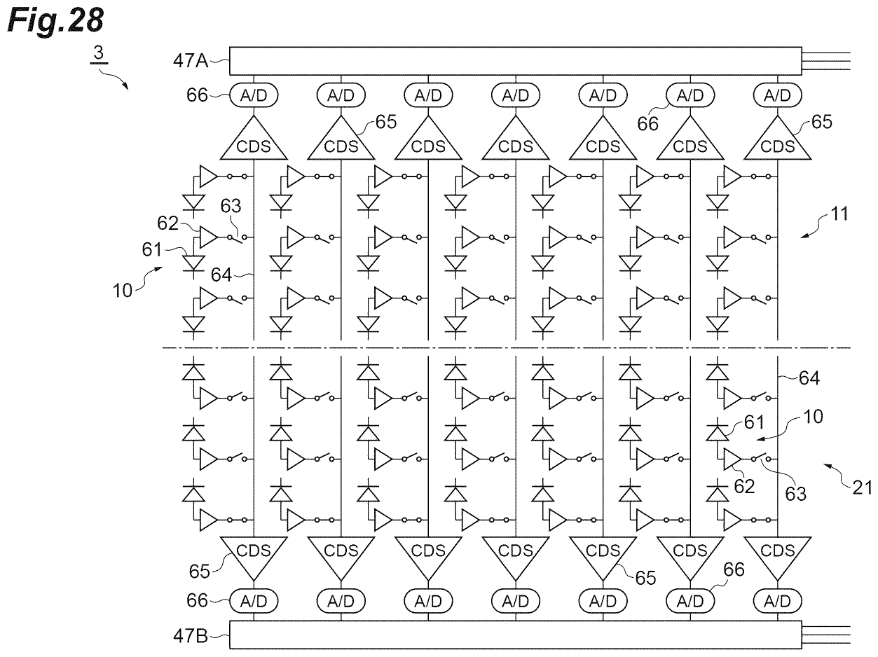

Alternatively, as illustrated in FIG. 28, the light detector 3 may be a complementary metal oxide semiconductor (CMOS) light detector including a first readout unit 47A and a second readout unit 47B. In this case, the first readout unit 47A outputs an electric signal corresponding to the magnitude of charges accumulated in each of the pixels 10 of the first detection unit 11, and the second readout unit 47B outputs an electric signal corresponding to the magnitude of charges accumulated in each of the pixels 10 of the second detection unit 21. In this case, for example, power consumption can be reduced as compared with a CCD light detector that reads out charges for each column. In addition, it is possible to avoid an increase in readout noise when charges generated in each pixel are read out.

FIG. 28 illustrates a photodiode 61 and an amplifier 62 constituting the pixel 10. The photodiode 61 accumulates electrons (photoelectrons) generated by inputting the measurement light L as charges. The amplifier 62 converts the charge accumulated in the photodiode 61 into an electric signal (for example, signal indicating a voltage value) and amplifies the electric signal. By switching of a selection switch 63 of each pixel 10, the electric signal amplified by the amplifier 62 is transferred to a vertical signal line 64 that connects the pixels 10 in the row direction to each other. A correlated double sampling (CDS) circuit 65 is disposed in each vertical signal line 64. The CDS circuit 65 reduces readout noise between the pixels 10, and temporarily stores the electric signal transferred to the vertical signal line 64. An AD converter 66 converts a voltage value stored in the CDS circuit 65 into a digital value. A digital value corresponding to the first detection unit 11 is output to the processing unit 4 via the first readout unit 47A. A digital value corresponding to the second detection unit 21 is output to the processing unit 4 via the second readout unit 47B.

In the above embodiment, the first pixel column 12 includes the plurality of pixels 10, but the first pixel column 12 only needs to include at least one pixel 10, and may include only one pixel 10. Similarly, the second pixel column only needs to include at least one pixel 10, and may include only one pixel 10. That is, each of the first detection unit 11 and the second detection unit 21 may include the pixels 10 arranged in one column in the first direction D1. The light detector 3 may be a time delay integration (TDI) line sensor or a one-dimensional line sensor.

In the above-described example, the proximity channel is a channel adjacent to the target channel, but as described above, the proximity channel may be a channel within a range from a channel immediately adjacent to the channel to a channel three channels away from the channel. In the above-described example, for the first signal S1 or the second signal S2, only a difference from one proximity channel adjacent to the target channel on one side in the first direction D1 is considered, but differences from two or more proximity channels may be considered. For example, instead of the difference A1, an average value of the difference A1 that is a difference from a channel immediately adjacent to the target channel and a difference from a channel two channels away from the target channel may be used for setting the threshold. Similarly, instead of the difference A1, an average value (moving average value) of differences from five channels within a range from a channel immediately adjacent to the channel to a channel five channels away from the channel may be used for setting the threshold.

The threshold only needs to be set to a value corresponding to the difference value, and does not necessarily have to be set to an average value of the difference values. The average value is not limited to an arithmetic average, and may be a weighted average or the like. The first exposure time of the first detection unit 11 may be equal to the second exposure time of the second detection unit 21. In the above-described example, the processing unit 4 interpolates a value of a channel identified as including noise in the first signal S1 or the second signal S2 based on values of channels on both sides of the channel, but the interpolation does not have to be performed, and for example, the value of the channel identified as including noise may be simply excluded from acquired data. The noise detection method of the present embodiment can be applied not only to detection of noise caused by a cosmic ray but also to detection of other noise that is generated suddenly. The light detection device 5 may be applied to an application other than the spectrometer 1.

### REFERENCE SIGNS LIST

1: Spectrometer, 2: Spectroscopic unit, 3: Light detector, 4: Processing unit, 5: Light detection device, 10: Pixel, 11: First detection unit, 12: First pixel column, 21: Second detection unit, 22: Second pixel column, 31: First horizontal shift register, 32: Second horizontal shift register, 45A: First accumulation unit, 45B: Second accumulation unit, 46A, 47A: First readout unit, 46B, 47B: Second readout unit, 100: Semiconductor process monitoring device, 101: Film thickness measurement device, A1, A2, B1, B2: Difference, D1: First direction, D2: Second direction, L: Measurement light, S1: First signal, S2: Second signal.

1. A light detection device comprising:
a light detector configured to detect measurement light; and
circuitry configured to process data output from the light detector,
wherein the light detector comprises:
a first detector comprising a plurality of first pixel columns arranged along a first direction, wherein each of the plurality of first pixel columns comprises at least one pixel arranged along a second direction perpendicular to the first direction; and
a second detector comprising a plurality of second pixel columns arranged along the first direction, wherein each of the plurality of second pixel columns comprises at least one pixel arranged along the second direction, wherein the first detector and the second detector are arranged so as to be adjacent to each other in the second direction,
wherein the light detector outputs a first signal and a second signal to the circuitry, wherein the first signal is one-dimensional data in the first direction of the measurement light detected by the first detector, wherein the second signal is one-dimensional data in the first direction of the measurement light detected by the second detector,
wherein the light detector comprises a plurality of channels arranged along the first direction assuming that one channel is formed by the first pixel column and the second pixel column arranged in the second direction,
wherein the circuitry sets a threshold respectively for each of the plurality of channels,
wherein the circuitry identifies a target channel among the plurality of channels based on the threshold and a signal difference between the first signal and the second signal in each of the plurality of channels, wherein noise is included in the first signal or the second signal of the target channel,
wherein the threshold is set for each of the plurality of channels based on the first signal and the second signal.

2. The light detection device according to claim 1, wherein the threshold is set for each of the plurality of channels based on a magnitude of the first signal and a magnitude of the second signal.

3. The light detection device according to claim 1, wherein the threshold is set based on:
a first difference between a value of the first signal in a referring channel among the plurality of channels and a value of the first signal in a first proximity channel which is proximate to the referring channel; and
a second difference between a value of the second signal in the referring channel and a value of the second signal in a second proximity channel which is proximate to the referring channel.

4. The light detection device according to claim 1, wherein the circuitry creates threshold addition data obtained by adding the threshold to whichever of the first signal and the second signal is smaller for each of the plurality of channels, and compares the first signal and the second signal with the threshold addition data to identify the target channel.

5. The light detection device according to claim 1,
wherein the first signal is the one-dimensional data of the measurement light detected during a first exposure time by the first detector,
wherein the second signal is the one-dimensional data of the measurement light detected during a second exposure time by the second detector, and
wherein the second exposure time is longer than the first exposure time.

6. The light detection device according to claim 1, wherein the circuitry interpolates a value of the target channel based on values of channels on both sides of the target channel.

7. The light detection device according to claim 1,
wherein the light detector comprises a CCD light detector comprising:
a first horizontal shift register to which charges generated in the plurality of first pixel columns of the first detector are transferred; and
a second horizontal shift register to which charges generated in the plurality of second pixel columns of the second detector are transferred.

8. The light detection device according to claim 1,
wherein the light detector comprises a CCD light detector comprising:
a plurality of first accumulation circuits in which charges generated in the plurality of first pixel columns of the first detector are accumulated respectively;
a plurality of second accumulation circuits in which charges generated in the plurality of second pixel columns of the second detector are accumulated respectively;
a plurality of first readout circuits electrically connected to the plurality of first accumulation circuits respectively, and configured to output electric signals corresponding to a magnitude of charges accumulated in the plurality of first accumulation circuits; and
a plurality of second readout circuits electrically connected to the plurality of second accumulation circuits respectively, and configured to output electric signals corresponding to a magnitude of charges accumulated in the plurality of second accumulation circuits.

9. The light detection device according to claim 1,
wherein the light detector comprises a CMOS light detector comprising:
a first readout circuit unit configured to output an electric signal corresponding to a magnitude of charges accumulated in each of the pixels of the first detector; and
a second readout circuit configured to output an electric signal corresponding to a magnitude of charges accumulated in each of the pixels of the second detector.

10. A spectrometer comprising:
a spectroscope configured to spectrally disperse the measurement light and form an image over the first detector and the second detector; and
the light detection device according to claim 1, configured to detect the measurement light spectrally dispersed by the spectroscope through the first detector and the second detector.

11. A film thickness measurement device comprising:
the spectrometer according to claim 10; and
a light source configured to generate light to be irradiated to an object,
wherein the circuitry measures a film thickness of the object based on data from which the noise has been removed.

12. A semiconductor process monitoring device comprising:
the spectrometer according to claim 10; and
at least one semiconductor processor configured to process a semiconductor device according to a predetermined work description,
wherein the light detector detects the measurement light generated in the semiconductor processor when the semiconductor processor processes the semiconductor device according to the predetermined work description, and
wherein the circuitry monitors an abnormality occurred while the semiconductor processor processes the semiconductor device according to the predetermined work description, based on data from which the noise has been removed.

13. A noise detection method using a light detector comprising: a first detector comprising a plurality of first pixel columns arranged along a first direction, each of the plurality of first pixel columns comprising at least one pixel arranged along a second direction perpendicular to the first direction; and a second detector comprising a plurality of second pixel columns arranged along the first direction, each of the plurality of second pixel columns comprising at least one pixel arranged along the second direction, the first detector and the second detector being arranged so as to be adjacent to each other in the second direction, wherein the light detector comprises a plurality of channels arranged along the first direction assuming that one channel is formed by the first pixel column and the second pixel column arranged in the second direction,
the method comprising:
outputting a first signal and a second signal, wherein the first signal is one-dimensional data in the first direction of the measurement light detected by the first detector, wherein the second signal is one-dimensional data in the first direction of the measurement light detected by the second detector;
setting a threshold respectively for each of the plurality of channels; and
identifying a target channel among the plurality of channels based on the threshold and a signal difference between the first signal and the second signal in each of the plurality of channels, wherein noise is included in the first signal or the second signal of the target channel,
wherein in setting the threshold, the threshold is set for each of the plurality of channels based on the first signal and the second signal.

14. The light detection device according to claim 1, wherein each of the plurality of first pixel columns comprises a plurality of pixels arranged along the second direction, and each of the plurality of second pixel columns comprises a plurality of pixels arranged along the second direction.

15. The light detection device according to claim 1, wherein the circuitry dynamically sets the threshold based on the first signal obtained in real time by the first detector and the second signal obtained in real time by the second detector.

16. The light detection device according to claim 1, wherein the threshold is set based on a magnitude of shot noise included in each of the first signal and the second signal.

17. The light detection device according to claim 1, wherein the first direction is along a wavelength-dispersing direction by a spectroscope, and the circuitry sets the threshold for each of a plurality of wavelengths corresponding to the plurality of channels.

18. The light detection device according to claim 1, wherein the noise is a noise having a size so as to be detected in only one of the first detector and the second detector.
